(19) United States
(12) Patent Application Publication
(10) Pub. No.: US 2026/0235914 A1
(43) Pub. Date: Aug. 13, 2026

(54) DISPLAY SUBSTRATE AND DISPLAY DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Weili ZHAO, Beijing (CN); Hehe HU, Beijing (CN); Zheng FANG, Beijing (CN); Pengxia LIANG, Beijing (CN); Peirou LI, Beijing (CN); Qian JIA, Beijing (CN); Xue DONG, Beijing (CN)

(21) Appl. No.: 19/150,790

(22) PCT Filed: Jun. 25, 2024
(86) PCT No.: PCT/CN2024/101430

§ 371 Date: Jul. 24, 2025

(30) Foreign Application Priority Data
Jun. 27, 2023 (CN) 202310769073.6
Nov. 30, 2023 (CN) 202311630471.6

(51) Int. Cl. G02F 1/1362

(52) U.S. Cl. CPC G02F 1/136286; G02F 1/136209; G02F 1/136222

(57) ABSTRACT

A display substrate includes an array substrate and a color filter substrate. The array substrate includes a first base, first signal lines and signal line groups. A protruding structure, protruding toward a side away from the first base, is formed in an overlapping region of orthographic projections of a signal line group and a first signal line on the first base. The signal line group include avoidance regions. An intersection of at least one signal line group and a first signal line is provided with an avoidance region. The color film substrate includes a second base and spacers. An orthographic projection of a spacer on the array substrate partially overlaps with the first signal line, and partially overlaps with the signal line group. In the avoidance region, the orthographic projection of the spacer on the array substrate does not overlap with the protruding structure.

### CROSS-REFERENCE TO RELATED APPLICATIONS

This application is a national phase entry under 35 USC 371 of International Patent Application No. PCT/CN2024/101430, filed on Jun. 25, 2024, which claims priorities to Chinese Patent Application No. 202310769073.6, filed on Jun. 27, 2023 and Chinese Patent Application No. 202311630471.6, filed on Nov. 30, 2023, which are incorporated herein by reference in their entirety.

### TECHNICAL FIELD

The present disclosure relates to the field of display technologies, and in particular, to a display substrate and a display device.

### BACKGROUND

With the development of display technologies, display devices (such as mobile phones, televisions, and computers) have been widely used. Common display devices may include liquid crystal display (LCD) devices and organic light-emitting diode (OLED) display devices. Due to the simpler pixel circuit structure of liquid crystal display devices (which may include fewer thin film transistors and capacitors), liquid crystal display devices have more advantages in display products with ultra-high pixel density (for example, greater than or equal to 1000 PPI).

In the liquid crystal display device, spacers are usually used to maintain the stability and uniformity of the thickness of the liquid crystal cell. The design of the spacers will also affect the yield of the alignment film and the light output rate of the liquid crystal display substrate. Optimizing the structure of the spacers to improve the performance of the display device is an important research direction of current liquid crystal display devices.

### SUMMARY

In an aspect, a display substrate is provided. The display substrate includes an array substrate and a color filter substrate arranged opposite to each other. The array substrate includes a first base, a plurality of first signal lines disposed on a side of the first base, and a plurality of signal line groups. The plurality of first signal lines are arranged at intervals in a first direction and all extend in a second direction, and the plurality of signal line groups are arranged at intervals in the second direction and all extend in the first direction, the first direction and the second direction intersecting. The plurality of first signal lines and the plurality of signal line groups intersect with each other to constitute a mesh structure. A protruding structure, protruding toward a side away from the first base, is formed in an overlapping region of orthographic projections of a signal line group and a first signal line on the first base. The signal line group include avoidance regions; and an intersection of at least one signal line group and a first signal line is provided with an avoidance region. The color film substrate includes a second base and a plurality of spacers, wherein the plurality of spacers are disposed on a side of the second base close to the array substrate; the spacers are in a strip shape and extend in the first direction; an orthographic projection of a spacer on the array substrate partially overlaps with the first signal line, and partially overlaps with the signal line group; and in the avoidance region, the orthographic projection of the spacer on the array substrate does not overlap with the protruding structure.

In some embodiments, a surface of the spacer away from the second base abuts against a portion of the protruding structure.

In some embodiments, a distance between a surface of the spacer away from the second base and the second base is equal.

In some embodiments, in the avoidance region, the signal line group protrudes in the first direction.

In some embodiments, the signal line group includes a second signal line, an orthographic projection of the second signal line on the second base partially overlaps with the spacer, a dimension of a surface of the spacer close to the array substrate in the second direction is D1, a width of the second signal line in the second direction is D2, and D1 is greater than D2.

In some embodiments, the signal line group includes a second signal line and a third signal line; the orthographic projection of the spacer on the array substrate also covers a region between the second signal line and the third signal line; the orthographic projection of the spacer on the array substrate partially overlaps with the second signal line; and the orthographic projection of the spacer on the array substrate partially overlaps with the third signal line.

In some embodiments, a dimension of a surface of the spacer close to the array substrate in the second direction is D1, a dimension of the second signal line in the second direction is D2, a dimension of the third signal line in the second direction is D3, and a distance between the second signal line and the third signal line is D4. D1, D2, D3 and D4 satisfy: D2>D3, and D1=D4+D3; or, D1, D2, D3 and D4 satisfy: D3>D2, and D1=D4+D2.

In some embodiments, an intersection of at least one second signal line and the first signal line is provided with an avoidance region, and/or an intersection of at least one third signal line and the first signal line is provided with an avoidance region.

In some embodiments, the array substrate further includes a first electrode, and a surface, in the first direction, of a protruding structure of the third signal line in the avoidance region is connected to the first electrode.

In some embodiments, a dimension of the spacer in the first direction is greater than a distance between two adjacent first signal lines.

In some embodiments, the plurality of spacers include at least one first spacer; an orthographic projection of a first spacer on the array substrate overlaps with at least thirteen first signal lines, and overlaps with one signal line group; and at least eleven intersections among intersections of the at least thirteen first signal lines and the one signal line group are provided with avoidance regions.

In some embodiments, the mesh structure composed of the plurality of first signal lines and the plurality of signal line groups defines a plurality of pixel regions; and at least one first spacer is arranged for every twenty-four pixel regions.

In some embodiments, the plurality of spacers include at least one second spacer, an orthographic projection of a second spacer on the array substrate overlaps with three first signal lines, and overlaps with one signal line group; and the second spacer abuts against protruding structures formed at intersections of the three first signal lines and the one signal line group.

In some embodiments, the plurality of spacers include at least one third spacer; an orthographic projection of a third spacer on the array substrate overlaps with one first signal line, and overlaps with one signal line group; and the third spacer abuts against a protruding structure formed at an intersection of the one first signal line and the one signal line group.

In some embodiments, the plurality of spacers include at least one fourth spacer; an orthographic projection of a fourth spacer on the array substrate overlaps with three first signal lines, and overlaps with one signal line group. An intersection of the three first signal lines and the one signal line group is provided with two avoidance regions. The fourth spacer abuts against a protruding structure formed at an intersection of one first signal line among the three first signal lines and the one signal line group.

In some embodiments, the plurality of spacers include at least one fifth spacer; an orthographic projection of a fifth spacer on the array substrate overlaps with three first signal lines, and overlaps with one signal line group; each intersection of the three first signal lines and the one signal line group is provided with an avoidance region; and the fifth spacer is not contact with protruding structures formed at intersections of the three first signal lines and the one signal line group.

In some embodiments, the mesh structure composed of the plurality of first signal lines and the plurality of signal line groups defines a plurality of pixel regions. The array substrate includes a plurality of fourth spacers and a plurality of fifth spacers; and four fourth spacers and four fifth spacers are arranged for every forty-eight pixel regions.

In some embodiments, the plurality of fourth spacers and the plurality of fifth spacers are arranged in rows in the first direction, and a row includes multiple fourth spacers and multiple fifth spacers that are alternately arranged; and/or the plurality of fourth spacers and the plurality of fifth spacers are arranged in columns in the second direction, and a column includes fourth spacers and fifth spacers that are alternately arranged.

In some embodiments, the spacer includes a main spacer region and a first secondary spacer region. The main spacer region abuts against the protruding structure, and a density of an orthographic projection of the main spacer region on the array substrate is in a range of 50 μm²/mm² to 300 μm²/mm². The first secondary spacer region is not in contact with the protruding structure, an orthographic projection of the first secondary spacer region on the array substrate overlaps with the first signal line or the signal line group; and a density of the orthographic projection of the first secondary spacer region on the array substrate is in a range of 5000 μm²/mm² to 20000 μm²/mm².

In some embodiments, the color filter substrate further includes a black matrix. The black matrix is disposed between the second base and the spacers, and an orthographic projection of the black matrix on the array substrate covers orthographic projections of the spacers on the array substrate, the first signal lines, and the signal line groups.

In some embodiments, the black matrix includes first portions and second portions. An orthographic projection of a first portion on the array substrate covers a portion of the first signal line close to the signal line group. A second portion is located on a side of the first portion away from the signal line group, and is connected to the first portion. A dimension of the first portion in the first direction is greater than a dimension of the second portion in the first direction.

In some embodiments, a thickness of the first signal line is in a range of 0.5 μm to 0.7 μm; and/or a thickness of the signal line group is in a range of 0.5 μm to 0.7 μm.

In some embodiments, the orthographic projection of the spacer on the array substrate partially overlaps with the signal line group or the first signal line; the spacer includes a main spacer region with a first thickness and a third secondary spacer region with a second thickness, and the first thickness is greater than the second thickness; an orthographic projection of the main spacer region on the array substrate overlaps with the first signal line; and the orthographic projection of the main spacer region on the array substrate does not overlap with the signal line group.

In some embodiments, the orthographic projection of the main spacer region on the array substrate overlaps with at least two first signal lines.

In another aspect, a display device is provided. The display device includes a driver circuit board and the display substrate as described in any of the above embodiments. The driver circuit board is electrically connected to the display substrate, and is configured to transmit control signals to the display substrate.

### BRIEF DESCRIPTION OF THE DRAWINGS

In order to describe technical solutions in some embodiments of the present disclosure more clearly, the accompanying drawings to be used in some embodiments of the present disclosure will be introduced briefly. However, the accompanying drawings to be described below are merely some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a display device, in accordance with some embodiments;

FIG. 2 is a diagram showing a composition structure of a display device, in accordance with some embodiments;

FIG. 3 is a diagram showing a structure of an array substrate in which a signal line group includes a second signal line and a third signal line, in accordance with some embodiments;

FIG. 4 is a sectional view taken along the line A1-A1 in FIG. 3;

FIG. 5 is a sectional view taken along the line A2-A2 in FIG. 3;

FIG. 6 is an equivalent circuit diagram of an array substrate, in accordance with some embodiments;

FIG. 7 is a diagram showing a structure of an array substrate in which a signal line group includes a second signal line, in accordance with some embodiments;

FIG. 8 is a sectional view taken along the line A3-A3 in FIG. 7;

FIG. 9 is an equivalent circuit diagram of another array substrate, in accordance with some embodiments;

FIG. 10 is a diagram showing a structure of a display substrate including second spacers, in accordance with some embodiments;

FIG. 11 is a sectional view taken along the line A4-A4 in FIG. 10;

FIG. 12 is a diagram showing a structure of a display substrate including a third spacer, in accordance with some embodiments;

FIG. 13 is a sectional view taken along the line A5-A5 in FIG. 12;

FIG. 14 is a diagram showing a structure of a display substrate including a fourth spacer, in accordance with some embodiments;

FIG. 15 is a sectional view taken along the line A6-A6 in FIG. 14;

FIG. 16 is a diagram showing a structure of a display substrate including a fifth spacer, in accordance with some embodiments;

FIG. 17 is a sectional view taken along the line A7-A7 in FIG. 16;

FIG. 18 is a diagram showing an arrangement structure of fourth spacers and fifth spacers, in accordance with some embodiments;

FIG. 19 is a diagram showing a structure of a display substrate in a case where a spacer is displaced, in accordance with some embodiments;

FIG. 20 is a diagram showing a thickness of a liquid crystal cell after being subjected to external force in a case where a spacer is not displaced, in accordance with some embodiments;

FIG. 21 is a diagram showing a thickness of a liquid crystal cell after being subjected to external force in a case where a spacer is displaced, in accordance with some embodiments;

FIG. 22 is a diagram showing a deformation amount of a spacer after being displaced and subjected to external force, in accordance with some embodiments;

FIG. 23 is a structural diagram of spacers and an array substrate, in accordance with some embodiments;

FIG. 24 is a sectional view taken along the line A8-A8 in FIG. 23;

FIG. 25 is a structural diagram of a black matrix and an array substrate, in accordance with some embodiments;

FIG. 26 is a diagram showing a projection relationship between a black matrix and a first signal line, in accordance with some embodiments;

FIG. 27 is a schematic plan view of an array substrate in a display substrate, in accordance with some embodiments;

FIG. 28 is a sectional view taken along the line B1-B1 in FIG. 27;

FIG. 29 is a sectional view taken along the line B2-B2 in FIG. 27;

FIG. 30 is a schematic plan view of another array substrate, in accordance with some embodiments;

FIG. 31 is a schematic plan view of yet another array substrate, in accordance with some embodiments;

FIG. 32 is a schematic plan view of yet another array substrate, in accordance with some embodiments;

FIG. 33 is a schematic plan view of yet another array substrate, in accordance with some embodiments;

FIG. 34 is a sectional view taken along the line B3-B3 in FIG. 27;

FIG. 35A is a schematic sectional view of an array substrate in which a spacer material layer has been deposited;

FIG. 35B is a schematic sectional view of an array substrate in which a photoresist pattern has been formed;

FIG. 35C is a schematic sectional view of an array substrate in which first spacers have been formed;

FIG. 36 is a schematic plan view of an array substrate in a display substrate, in accordance with some embodiments;

FIG. 37 is a schematic sectional view of a display substrate in the related art; and

FIG. 38 is a schematic diagram showing a size comparison of an opaque pattern in an array substrate in the related art and an opaque pattern in the present disclosure.

### DETAILED DESCRIPTION

Technical solutions in some embodiments of the present disclosure will be described clearly and completely with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least some embodiments or examples of the present disclosure. Schematic representations of the above terms do not necessarily refer to the same embodiment(s) or example(s). In addition, the specific features, structures, materials, or characteristics described may be included in any one or more embodiments or examples in any suitable manner.

In the present disclosure, terms such as “lower”, “below”, “above” and “upper” and the like are used to explain the relational association of components shown in the drawings. The terms may be relative concepts and described based on the directions shown in the drawings, or may be described based on the order in which the process steps are formed, but are not limited thereto.

It will be understood that, when a layer or element is referred to as being on another layer or substrate, it may be that the layer or element is directly on the another layer or substrate, or it may be that intermediate layer(s) exist between the layer or element and the another layer or substrate.

The term “opposed to” means that a first element may be directly or indirectly opposed to a second element. In a case where a third element is disposed between the first element and the second element, the first element and the second element may be understood as being indirectly opposite to each other although still opposite to each other.

The terms “first” and “second” are used for descriptive purposes only, and are not to be construed as indicating or implying a relative importance or implicitly indicating the number of indicated technical features. Thus, features defined with “first” or “second” may explicitly or implicitly include one or more of the features. In the description of the embodiments of the present disclosure, the term “multiple”, “a plurality of” or “the plurality of” means two or more unless otherwise specified.

In the description of some embodiments, terms such as “coupled” and “connected” and their derivatives may be used. The term “connected” should be understood in a broad sense. For example, the term “connected” may represent a fixed connection, or a detachable connection, or a one-piece connection; alternatively, the term “connected” may represent a direct connection, or an indirect connection through an intermediate medium. For example, the term “coupled” indicates that two or more components are in direct physical or electrical contact. The term “coupled” or “communicatively coupled” may also mean that two or more components are not in direct contact with each other but still cooperate or interact with each other. The embodiments disclosed herein are not necessarily limited to the content herein.

The phrase “at least one of A, B, and C” has the same meaning as the phrase “at least one of A, B, or C”, both including the following combinations of A, B, and C: only A, only B, only C, a combination of A and B, a combination of A and C, a combination of B and C, and a combination of A, B, and C.

The phrase “A and/or B” includes the following three combinations: only A, only B, and a combination of A and B.

The phrase “applicable to” or “configured to” used herein has an open and inclusive meaning, which does not exclude devices that are applicable to or configured to perform additional tasks or steps.

In addition, the phrase “based on” used is meant to be open and inclusive, since a process, step, calculation or other action that is “based on” one or more of the stated conditions or values may, in practice, be based on additional conditions or value exceeding those stated.

The term such as “about,” “substantially,” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be that, for example, a difference between the two that are equal is less than or equal to 5% of either of the two.

It will be understood that, when a layer or element is referred to as being on another layer or substrate, it may be that the layer or element is directly on the another layer or substrate, or it may be that intermediate layer(s) exist between the layer or element and the another layer or substrate.

Exemplary embodiments are described herein with reference to sectional views and/or plan views that are schematic illustrations of idealized embodiments. In the accompanying drawings, thicknesses of layers and sizes of regions are enlarged for clarity. Variations in shape with respect to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a feature being curved. Therefore, the regions shown in the accompanying drawings are schematic in nature, and their shapes are not intended to show actual shapes of the regions in a device, and are not intended to limit the scope of the exemplary embodiments.

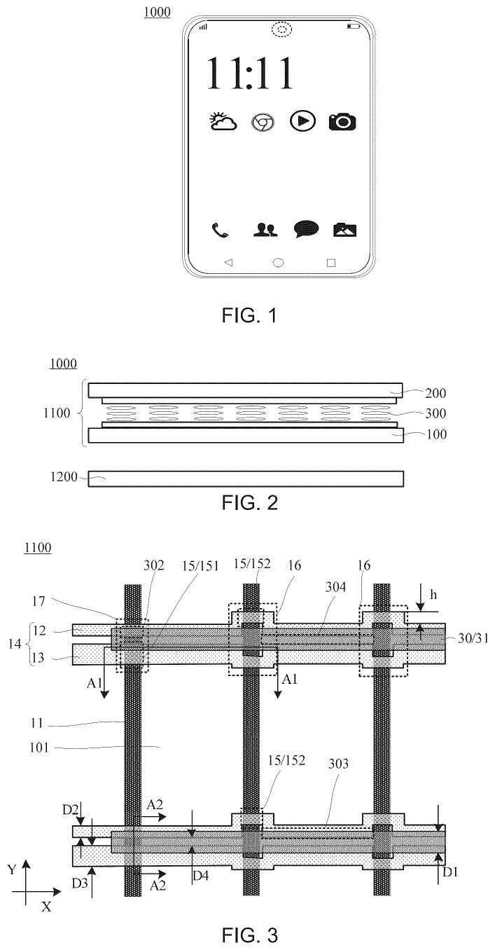

Referring to FIG. 1, embodiments of the present disclosure provide a display device, and the display device 1000 is a product having a function of displaying images. For example, the display device 1000 may be any device that displays images whether in motion (e.g., videos) or stationary (e.g., static images), and whether textual or graphical.

For example, the display device 1000 may be any product or component that has a display function, such as a television, a notebook computer, a tablet computer, a personal digital assistant (PDA), a mobile phone (cell phone), a watch, a dock, a calculator, a GPS receiver/navigator, a camera, a display in a camera view (e.g., a display of a rear camera in a vehicle), a wearable device, an augmented reality (AR) device, a virtual reality (VR) device, a mixed reality (MR) device, a vehicle-mounted display, or a flight display.

In some embodiments, the display device 1000 may be a liquid crystal display (LCD) device from the perspective of the light emission type of the display device 1000. The display device 1000 may be a flat display device or a curved display device from the perspective of the form of the display device 1000. The display device 1000 may have a rectangular or circular shape from the perspective of the shape of the display device 1000. Some embodiments of the present disclosure will be schematically described below by taking an example in which the display device is a rectangular flat liquid crystal display device. However, the embodiments of the present disclosure are not limited thereto, and any other display devices may also be taken into consideration as long as the same technical concept is applied.

In some embodiments, referring to FIG. 2, the display device 1000 includes a display substrate 1100 (which may also be referred to as a display panel) and a driver circuit board (not shown in the figure). The driver circuit board may include driving circuits such as a timing controller (TCON), a power supply management chip (DC/DC), and an adjustable resistor voltage divider circuit (for generating Vcom). The driver circuit board may also include other circuit structures, which will not be described in detail. The driver circuit board is electrically connected to the display substrate 1100, and is used for transmitting control signals to the display substrate 1100 to drive the display substrate 1100 display images. In addition, the display device 1000 may further include a touch structure, an under-display camera and an under-display fingerprint recognition sensor, so that the display device 1000 can realize various different functions such as touch, photographing, video recording, or fingerprint recognition, which will not be described in detail here.

With continued reference to FIG. 2, in the case where the display device 1000 is the liquid crystal display device, the display device 1000 may further include a backlight source 1200 disposed on a back side of the display substrate 1100. For example, the backlight source 1200 may be a direct-lit backlight source or an edge-lit backlight source. The backlight source 1200 is used to provide a light source for the display substrate 1100. The display substrate 1100 includes a plurality of sub-pixels, and each sub-pixel can adjust an amount of light that passes through the display substrate 1100 and is located within the sub-pixel, so that all sub-pixel display the same gray level or different gray levels to achieve the purpose of image display.

With continued reference to FIG. 2, in the case where the display substrate 1100 is a liquid crystal display substrate, the display substrate 1100 may include: an array substrate 100 and a color filter substrate 200 that are opposite to each other, and a liquid crystal layer 300 disposed between the array substrate 100 and the color filter substrate 200. The color filter substrate 200 may also be referred to as an opposite substrate or an encapsulation substrate. Of course, the structure of the display substrate 1100 is not limited thereto, and the display substrate 1100 may have other structures as long as the same technical concept is adopted. For example, the display substrate 1100 may further include a first alignment film (not shown in the figure) disposed on a side of the array substrate 100 close to the liquid crystal layer 300, and a second alignment film (not shown in the figure) disposed on a side of the color filter substrate 200 close to the liquid crystal layer 300.

The array substrate 100 may include, for example, a plurality of pixel circuits arranged in an array. The pixel circuit may include at least one thin film transistor (TFT) and at least one capacitor. For example, the pixel circuit may be a “1T1C” circuit, a “2T1C” circuit, or a “3T1C” circuit, where, ‘T’ refers to thin film transistor, a number preceding ‘T’ refers to a quantity of thin film transistors, “C” refers to capacitor, and a number preceding “C” refers to a quantity of capacitors. Of course, the structure of the pixel circuit in the embodiments of the present disclosure is not limited to this, as long as the same technical idea is adopted. For example, the array substrate 100 further includes first electrode(s) and second electrode(s), and the capacitor is created between the first electrode and the second electrode. During the operation of the display substrate, an electric field may be developed between the first electrode and the second electrode, and the electric field is used for driving deflection of liquid crystal molecules in a sub-pixel region, thereby adjusting the gray level displayed by the sub-pixel. The first electrode may be, for example, a common electrode, and the second electrode may be, for example, a pixel electrode.

For example, the array substrate 100 may be of an advanced super dimension switch (ADS) type or a high-aperture ratio high-advanced dimension switch (HADS) type. ADS technology forms a multi-dimensional electric field by using, in a same plane, electric fields generated at edges of a slit-electrode (one of the second electrode and the first electrode) and an electric field generated between the slit-electrode and a plate-like electrode (the other of the second electrode and the first electrode), to cause liquid crystal molecules along all orientations, between the slit electrodes as well as over the electrodes, within a liquid crystal cell to rotate, thereby improving working efficiency of the liquid crystal and increasing the light transmission efficiency, resulting in advantages of high resolution, high transmittance, low power consumption, wide viewing angle, high aperture ratio, low chromatic aberration, and no push mura.

The color filter substrate 200 may include, for example, a black matrix (not shown in the figure) and filter portions. The black matrix includes a plurality of openings, and each opening corresponds to a sub-pixel and is configured to form a light-emitting region of a sub-pixel. The filter portion is configured to filter light incident on the color filter substrate 200, so that each sub-pixel emits light of a single color. Different sub-pixels may emit light of the same or different colors, so that the display substrate 1100 realizes color display. For example, the filter portions may include red filter portions, green filter portions and blue filter portions; in this way, different sub-pixels may emit red light, green light and blue light, respectively; therefore, the display substrate realizes color display.

The display substrate 1100 further includes a plurality of spacers, and the spacers are disposed between the array substrate 100 and the color filter substrate 200 and are disposed in the liquid crystal layer 300. Ends (lower surfaces) of the spacers close to the array substrate support the array substrate 100, and ends (upper surfaces) close to the color filter substrate 200 support the color filter substrate 200. The spacers are configured to support the array substrate 100 and the color filter substrate 200, so as to maintain a thickness of the liquid crystal layer 300 between the array substrate 100 and the color filter substrate 200. For example, the spacers may be formed on the color filter substrate 200.

In a display substrate provided in the related art, spacers are cylinder-shaped or polygon-shaped structures. That is, cross sections, parallel to an array substrate, of the spacers are in a shape of a circle or polygon. In a normal case (when the display substrate is not subjected to pressure), an orthographic projection of a spacer on the array substrate at least partially overlaps with a signal line in the array substrate. The display substrate may cause the spacer to slide and deviate from its original position under external force. The spacer may scratch a first alignment film on the array substrate during sliding, causing light leakage in a scratched region of the first alignment film of the display substrate. In order to avoid the above-mentioned light leakage problem, a large-sized black matrix is generally designed. That is, a distance between a border of an orthographic projection of the black matrix on the array substrate and a border of the orthographic projection of the spacer on the array substrate is large. In this way, the black matrix can block the scratched region of the first alignment film and reduce the risk of light leakage of the display substrate. However, the above-mentioned arrangement of the spacers and the black matrix will result in a large area of the black matrix, which will affect (reduce) an aperture ratio of the display substrate and will not be conducive to improving the luminescent efficiency of the display substrate. In addition, the spacers generally include main spacers and secondary spacers. There is a certain difference in height (dimension in a direction perpendicular to the array substrate) between the main spacers and the secondary spacers. In the case where the display substrate is not subjected to pressure, the main spacers support the liquid crystal cell. In the case where the display substrate is subjected to external force, the main spacers deform; and in a case where the deformation of the main spacers is greater than or equal to the difference in height between the main spacers and the secondary spacers, the secondary spacers start to support the liquid crystal cell, to avoid that the main spacers deform too much and is difficult to recover, which results in pressed mura. The main spacers and the secondary spacers, which have unequal heights, are usually made of the same material and formed by a half-tone mask. The fabrication of the main spacers and secondary spacers is difficult and costly.

Referring to FIGS. 3, 4 and 5, in order to solve at least one of the above technical problems, some embodiments of the present disclosure provide a display substrate 1100 including an array substrate 100 and a color filter substrate 200. The array substrate 100 includes a first base 10, a plurality of first signal lines 11 disposed on a side of the first base 10, and a plurality of signal line groups 14. The color filter substrate 200 includes a second base 20 and a plurality of spacers 30.

The first base 10 and/or the second base 20 may be a rigid base. For example, the rigid base may be a glass base or a polymethyl methacrylate (PMMA) base. Alternatively, the first base 10 and/or the second base 20 may be a flexible base. For example, the flexible base may be a polyethylene terephthalate (PET) base, a polyimide (PI) base, or a polyethylene naphthalate (PEN) base. It will be understood that the types of the first base 10 and the second base 20 vary, and the types of the first base 10 and the second base 20 may be the same or different. The first base 10 and the second base 20 may be set according to actual needs, which will not be limited in the embodiments of the present disclosure.

The plurality of first signal lines 11 are arranged at intervals in a first direction X, and all extend in a second direction Y. The plurality of signal line groups 14 are arranged at intervals in the second direction Y, and all extend in the first direction X. The plurality of first signal lines 11 and the plurality of signal line groups 14 intersect with each other to constitute a mesh structure. One mesh of the mesh structure defines one pixel region 101. The first direction X and the second direction Y intersect; for example, the first direction X is perpendicular to the second direction Y.

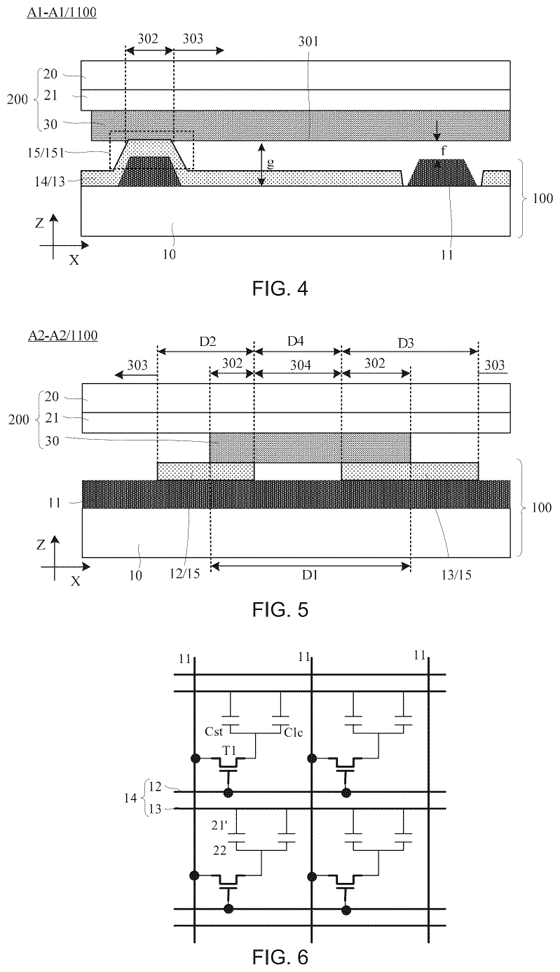

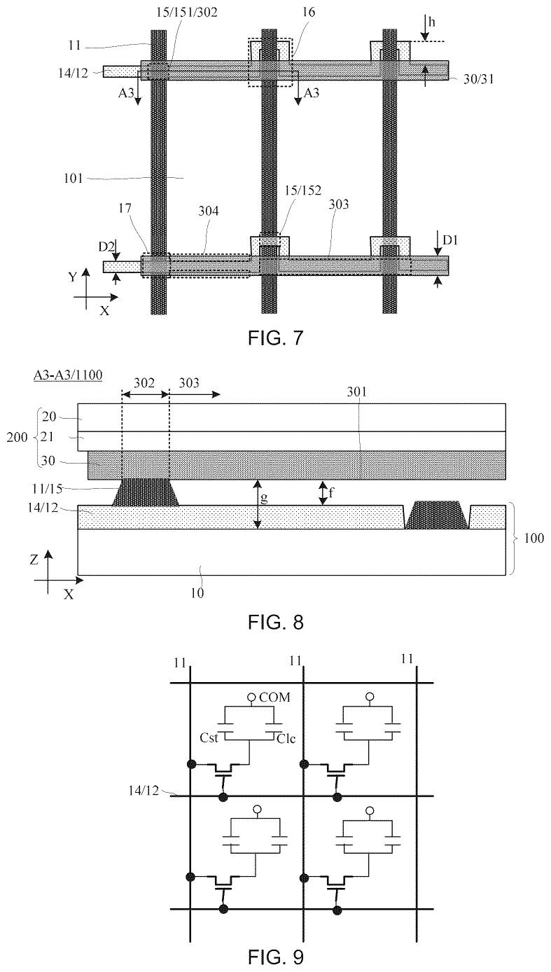

It will be noted that the first signal lines 11 and the signal line groups 14 are arranged in different layers, and at least one insulating layer is included between a film layer where the first signal lines 11 are located and a film layer where the signal line groups 14 are located, so that the first signal lines 11 are separated from the signal line groups 14 to prevent short circuits between the first signal lines 11 and the signal line groups 14. For example, the first signal lines 11 may be disposed on a side of the signal line groups 14 close to the first base 10 (as shown in FIG. 4); alternatively, the first signal lines 11 may be disposed on a side of the signal line groups 14 away from the first base 10 (as shown in FIGS. 7 and 8). In addition, the array substrate 100 may further include one or more whole-layer film layers, thicknesses of the whole-layer film layers are substantially uniform on the array substrate, and the surface morphology of the array substrate 100 will not be affected. Therefore, the whole-layer film layers are not shown in the figures provided in the embodiments of the present disclosure. For example, the array substrate may include a semiconductor layer, a first conductive layer (e.g., a film layer where the first signal lines (or the signal line groups) are located), a second conductive layer (e.g., a film layer where the signal line groups (or the first signal lines) are located), a first electrode layer, a second electrode layer, and at least one insulating layer disposed between adjacent conductive layers. The insulating layer may be the above-mentioned whole-layer film layer.

In the embodiments of the present disclosure, the array substrate 100 is not flattened, by a planarization layer (PLN), at least on a side, away from the first base 10, of the first signal lines 11 and the signal line groups 14. That is, a planarization layer is not provided on the side, away from the first base 10, of the first signal lines 11 and the signal line groups 14. Based on this, a surface of array substrate 100 close to the color filter substrate 200 have height difference caused by the first signal lines 11 and the signal line groups 14.

In some embodiments, the pixel region 101 may include a red pixel region, a green pixel region, or a blue pixel region. One pixel region 101 may correspond to one filter portion in the color filter substrate, and one type of pixel regions correspond to one-type of filter portions. An orthographic projection of the filter portion on the array substrate is located within the pixel region 101, and there may be a certain distance between a border of the orthographic projection of the filter portion on the array substrate and a border of the pixel region.

In some embodiments, referring to FIGS. 3 and 6, each pixel region 101 is controlled by one of first signal lines 11 and one of signal line groups 14, the first signal lines 11 and the signal line groups 14 enclosing the pixel region 101. For example, the first signal line 11 transmits a data signal to a second electrode of the pixel region 101 under control of a second signal line 12 of the signal line group 14 to charge a liquid crystal capacitor Clc and a storage capacitor Cst. An electric field may be developed between the second electrode and the first electrode to drive liquid crystal molecules of the liquid crystal layer to deflect. A deflection angle of the liquid crystal molecules may control a polarization direction of light passing through the pixel region 101, so as to display different gray levels in cooperation with a polarizer.

For example, referring to FIG. 6, the plurality of first signal lines 11 may be data signal lines. In this case, a first signal line 11 is electrically connected to a column of pixel circuits, and the first signal line 11 is configured to transmit a data signal to the column of pixel circuits. The signal line group 14 includes a second signal line 12 at least. For example, the second signal line 12 may be a scan signal line. In this case, a second signal line 12 is electrically connected to a row of pixel circuits. The second signal line 12 is configured to transmit a gate signal to pixel circuits, so that first signal lines 11 are controlled to transmit data signals to pixel circuits. For example, the pixel circuit may include a first transistor T1 and a storage capacitor Cst. The storage capacitor Cst may be developed by the first electrode 21′ and the second electrode. The first electrode 21′ may be a common electrode, and the second electrode 22 may be a pixel electrode. In this case, a gate of the first transistor T1 may be electrically connected to the second signal line 12, one of a source and a drain of the first transistor T1 may be electrically connected to the first signal line 11, and another of the source and the drain of the first transistor T1 may be electrically connected to an electrode of the storage capacitor developed by the first electrode 21′ and the second electrode 22. The second signal line 12 is used to control ON/OFF state of the first transistor T1, so that the first signal line 11 is controlled to write the data signal into the storage capacitor Cst.

Referring to FIGS. 3, 4 and 5, a protruding structure 15, protruding toward a side away from the first base 10, is formed in an overlapping region of orthographic projections of the signal line group 14 and the first signal line 11 on the first base 10. The protruding structure 15 is a structure of the surface of the array substrate 100 close to the color filter substrate 200, which protrudes toward the side away from the first base 10 relative to its adjacent regions. A shape of the protruding structure 15 may include but is not limited to column, cone or cuboid.

The signal line group 14 includes avoidance regions 16. An intersection of at least one signal line group 14 and a first signal line 11 is provided with an avoidance region 16. An extending direction of a portion of the signal line group 14 in the avoidance region 16 is different from that of other portions of the signal line group 14. In other words, the portion of the signal line group 14 in the avoidance region 16 deviates from the extending direction of the signal line group 14 (the first direction X). Based on this, a protruding structure 15 (a second protruding structure 152) formed in the avoidance region 16 and a protruding structure 15 (a first protruding structure 151) formed in a position (which may be called a non-avoidance region 17) where the avoidance region is not located are staggered in the second direction Y. In this way, among a plurality of protruding structures 15 formed by the same signal line group 14 and the plurality of first signal lines 11, first protruding structure(s) 151 and second protruding structure(s) 152 are not in a straight line parallel to the first direction X.

Referring to FIGS. 3, 4 and 5, the plurality of spacers 30 in the color filter substrate 200 are disposed on a side of the second base 20 close to the array substrate 100. The spacers 30 are in a strip shape and extend in the first direction X. An orthographic projection of the spacer 30 on the array substrate 100 partially overlaps with the first signal line 11, and partially overlaps with the signal line group 14. Since the spacer 30 extends in the first direction X, the orthographic projection of the spacer 30 on the array substrate 100 may partially overlap with at least one protruding structure 15 (at least one first protruding structure 151) that is not located at the position of the avoidance region 16 (located at the position of the non-avoidance region 17). In addition, in the avoidance region 16, the orthographic projection of the spacer 30 on the array substrate 100 does not overlap with the protruding structure 15 (the second protruding structure 152).

For example, the spacer 30 abuts against the protruding structure 15 (the first protruding structure 151) which is not located at the position of the avoidance region 16; and the spacer 30 is not in contact with the protruding structure 15 (the second protruding structure 152) in the avoidance region 16. In the embodiments of the present disclosure, due to the thickness of the signal line group 14 and the thickness of the first signal line 11 as well as the strip-shaped spacer 30, different spacers are formed in the avoidance region 16 and the non-avoidance region 17, that is, a main spacer is formed in the non-avoidance region 17, and a secondary spacer is formed in the avoidance region 16, which is conducive to reducing the difficulty of fabricating the spacers 30 and reducing the cost of fabricating the spacers 30. In addition, by providing the avoidance region 16, a contact area between the spacer 30 and the array substrate 100 may be adjusted, which is conducive to improving a ratio between the main spacer (a main spacer region) and the secondary spacer (a secondary spacer region) formed by the spacer 30, to meet the usage requirements of the display substrate for the spacer 30.

In some embodiments, the thickness of the first signal line 11 (a dimension of the first signal line 11 in a direction perpendicular to the first base 10) is in a range of 0.5 μm to 0.7 μm. In this way, it is conducive to increasing a height difference (step difference) between the first signal line 11 and the first base 10, and further conducive to forming protruding structures 15 in the surface of the array substrate 100 close to the color filter substrate 200. For example, the thickness of the first signal line 11 is 0.5 μm, 0.55 μm, 0.6 μm, or 0.7 μm, which will not be listed one by one in the embodiments of the present disclosure. In some embodiments, the thickness of the signal line group 14 is in a range of 0.5 μm to 0.7 μm, which is conducive to increasing a height difference between a region where the signal line group 14 is located and the first base 10, and further conducive to forming protruding structures (first secondary spacer regions) formed by the signal line group 14 in the surface of the array substrate 100 close to the color filter substrate 200. For example, the thickness of the signal line group 14 is 0.5 μm, 0.55 μm, 0.6 μm, or 0.7 μm, which will not be listed one by one in the embodiments of the present disclosure.

For example, a material of the first signal line 11 may include a conductive material, and the conductive material may include a metal material, such as one or more of titanium, aluminum, copper, molybdenum, niobium, nickel, and alloys thereof. Alternatively, the first signal line 11 may be of a metal stacked structure. For example, the first signal line 11 may include one or a combination of a titanium-aluminum-titanium (Ti/Al/Ti) stacked structure, a molybdenum-aluminum (Mo/Al) stacked structure, a molybdenum-aluminum-molybdenum (Mo/Al/Mo) stacked structure, a molybdenum-niobium-titanium (MoNb/Ti) stacked structure, a molybdenum-niobium-titanium-copper (MoNb/Ti/Cu) stacked structure, a molybdenum-niobium-copper (MoNb/Cu) stacked structure, a molybdenum-nickel-titanium-copper (MTD/Cu) stacked structure, a molybdenum-niobium-copper-molybdenum-nickel-titanium (MoNb/Cu/MTD) stacked structure, a molybdenum-nickel-titanium-copper-molybdenum-nickel-titanium (MTD/Cu/MTD) stacked structure, a molybdenum-neodymium-copper stacked structure, a MoNb-copper-MoNb stacked structure, and an AlNb-molybdenum-AlNd stacked structure. For example, a material of the signal line group 14 may include a conductive material. As for the conductive material, reference is made to the above description, and details will not be repeated. In addition, the material and structure of the signal line group 14 may be the same as or different from those of the first signal line 11, which can be set according to actual needs.

In some embodiments, with continued reference to FIGS. 3, 4 and 5, a surface 301 of the spacer 30 away from the second base 20 abuts against a part of protruding structures 15, and a portion of the surface 301 of the spacer 30 away from the second base 20 abutting against the protruding structure 15 forms a main spacer region 302. In addition, a portion of the orthographic projection of the spacer 30 on the array substrate 100 that overlaps with the first signal line 11 or the signal line group 14 but does not overlap with the protruding structure 15 forms a first secondary spacer region 303. A portion of the orthographic projection of the spacer 30 on the array substrate 100 overlapping with a region between a second signal line 12 and a third signal line 13 in the signal line group 14 forms a second secondary spacer region 304.

An end of the protruding structure 15 (the first protruding structure 151) close to the color filter substrate 200 abuts against the main spacer region 302 of the spacer 30. A distance between a surface, close to the color filter substrate 200, of a portion of the first signal line 11 (or the signal line group 14) where the protruding structure 15 is not located and the spacer 30 is f. A distance between a region, which is between the second signal line 12 and the third signal line 13 in the signal line group 14, and the spacer 30 is g. In some embodiments, g>f>0. In this way, the spacer 30 cooperates with the first signal line 11 and the signal line group 14 to form the main spacer region (a main spacer) 302, the first secondary spacer region (a first secondary spacer) 303, and the second secondary spacer region (a second secondary spacer) 304 which have a step difference. That is, the spacer 30 may form different spacer regions due to the height difference formed in a surface of the array substrate 100 close to the color filter substrate 200.

In a case where the display substrate 1100 is in a normal state (under no pressure), the main spacer region 302 of the spacer 30 provides support for a thickness of the liquid crystal cell. When the display substrate 1100 is under pressure, the color filter substrate 200 is pressed toward a side close to the array substrate 100, the spacer 30 is pressed and deformed, and the first secondary spacer region 303 of the spacer 30 starts to participate in supporting the thickness of the liquid crystal cell, that is, the spacer 30 is in contact with portions of an upper surface (a surface close to the color filter substrate) of the array substrate 100 where the second signal line 12 and the third signal line 13 are located. When the pressure on the display substrate 1100 continues to increase, a degree of the color filter substrate 200 being pressed toward the array substrate 100 increases, and a deformation degree of the spacer 30 further increases. At this time, the second secondary spacer region 304 starts to participate in supporting the thickness of the liquid crystal cell, that is, the spacer 30 is further in contact with a portion of the upper surface of the array substrate 100 between the second signal line 12 and the third signal line 13.

In some embodiments, as shown in FIG. 4, a distance between the surface 301 of the spacer 30 away from the second base 20 and the second base 200 is equal. In this way, due to the undulating structure on the surface of the array substrate 100 close to the color filter substrate 200 and the position of the spacer 30, the spacer 30 can realize the functions of the main spacer (main spacer region 302) and the secondary spacer (first secondary spacer region 303 or second secondary spacer region 304), and there is no need to use a half-tone mask to fabricate the spacer 30 of non-uniform thickness. For example, the spacer 30 may be formed by coating and patterning processes; and in the patterning process, the spacer 30 may be patterned by a conventional mask (compared to a half-tone mask). In this way, the difficulty and cost of fabricating the spacer 30 may be greatly reduced, thereby reducing the cost of the display substrate.

In some embodiments, referring to FIG. 3, the signal line group 14 may include a second signal line 12 and a third signal line. In the case where the signal line group 14 includes the second signal line 12 and the third signal line 13, in the non-avoidance region 17, the second signal line 12 and the third signal line 13 extend in a length direction of the signal line group 14, that is, extend in the first direction X. In the avoidance region 16, the second signal line 12 is bent and extends a certain distance in a direction away from the third signal line 13, then extends in the length direction of the signal line group 14, and is bent and extends in a direction close to the third signal line 13 to be colinear with the second signal line 12 in the non-avoidance region 17 after bypassing the protruding structure 15 of the first signal line 11, and then continues to extend in the length direction of the signal line group 14. That is, in the avoidance region 16, the second signal line 12 protrudes in the second direction Y to avoid the spacer 30. In the avoidance region 16, the third signal line 13 is bent and extends a certain distance in a direction away from the second signal line 12, then extends in the length direction of the signal line group 14, and is bent and extends in a direction close to the second signal line 12 to be colinear with the third signal line 13 in the non-avoidance region 17 after bypassing the protruding structure 15, and then continues to extend in the length direction of the signal line group 14. That is, in the avoidance region 16, the third signal line 13 protrudes in the second direction Y to avoid the spacer 30. In this way, an original main spacer region 302 in the avoidance region 16 is changed to a first secondary spacer region 303. That is to say, the avoidance region 16 may decrease the main spacer region 302 and increase the first secondary spacer region 303.

For example, in the avoidance region 16, the second signal line 12 is bent and extends in the direction away from the third signal line 13 by a distance h, and a maximum alignment deviation between the array substrate 100 and the color filter substrate 200 in the second direction Y is e, where h is greater than or equal to e. A structure that the spacer 30 is sandwiched between the second signal line 12 and the third signal line 13 is formed in the avoidance region 16, which may effectively prevent the spacer 30 from being displaced in the second direction Y.

In some embodiments, referring to FIGS. 3 and 6, the signal line group 14 includes a second signal line 12 and a third signal line 13. As for the structure and function of the second signal line 12, reference is made to the above description, and details will not be repeated. The third signal line 13 is configured to be connected to the first electrode, and the third signal line 13 is further configured to provide a stable voltage to an end of the liquid crystal capacitor Clc and an end of the storage capacitor Cst, so that the liquid crystal capacitor Clc and the storage capacitor Cst maintain a stable voltage difference, which makes the liquid crystal molecules maintain a directional deflection angle.

In some embodiments, the third signal line 13 is provided with a connection via near an intersection of the third signal line 13 and the first signal line 11, and the third signal line 13 is connected to the first electrode through the connection via hole. Since the connection via hole is disposed near the intersection of the third signal line 13 and the first signal line 11, when light leakage occurs due to the connection via hole, a black matrix 21 can block light leaking from the connection via hole, reducing the adverse effect of the connection via hole on the display effect of the display substrate 1100.

For example, referring to FIGS. 3 and 6, a single signal line group 14 includes a single second signal line 12 and a single third signal line 13. The second signal line 12 controls ON/OFF relationships between the plurality of first signal lines 11 and second electrodes of a row of pixel regions 101 through a row of thin film transistors. The third signal line 13 provides a stable voltage for ends of liquid crystal capacitors Clc and ends of storage capacitors Cst of an adjacent row of pixel regions 101.

In some embodiments, referring to FIG. 3, the orthographic projection of the spacer 30 on the array substrate 100 covers the region between the second signal line 12 and the third signal line 13 in the signal line group 14. In addition, the orthographic projection of the spacer 30 on the array substrate 100 partially overlaps with the second signal line 12, and the orthographic projection of the spacer 30 on the array substrate 100 partially overlaps with the third signal line 13. That is, within a length range of the spacer 30, the orthographic projection of the spacer 30 on the array substrate 100 covers a part of the second signal line 12, a part of the third signal line 13, and the region between the second signal line 12 and the third signal line 13.

In some embodiments, referring to FIGS. 3 and 5, a dimension, in the second direction Y, of the surface 301 of the spacer 30 close to the array substrate 100 is D1, a dimension of the second signal line 12 in the second direction Y is D2, a dimension of the third signal line 13 in the second direction Y is D3, and a distance between the second signal line 12 and the third signal line 13 is D4. In a case where the dimension D3 of the third signal line 13 in the second direction Y is greater than the dimension D2 of the second signal line 12 in the second direction Y (D3>D2), D1=D4+D2. Alternatively, in case where the dimension D2 of the second signal line 12 in the second direction Y is greater than the dimension D3 of the third signal line 13 in the second direction Y (D2>D3), D1=D4+D3. That is to say, the dimension D1, in the second direction Y, of the surface 301 of the spacer 30 close to the array substrate 100 is equal to a sum of the distance D4 between the second signal line 12 and the third signal line 13 and the smaller one of the dimensions of the second signal line 12 and the third signal line 13 in the second direction Y. In this way, even if there is a certain alignment deviation between the spacer 30 and the array substrate 100, in a case where the spacer at least partially covers the region between the second signal line 12 and the third signal line 13, the total area that the spacer 30 is in contact with the second signal line 12 and the third signal line 13 remains unchanged. In this way, it may ensure that the spacer 30 provides stable support for the liquid crystal layer 300, ensure that the liquid crystal layer 300 may maintain a stable thickness, and in turn ensure the display effect of the display substrate.

In some embodiments, as shown in FIG. 3, the signal line group 14 is provided with a plurality of avoidance regions 16 in the length direction of the signal line group 14 (the first direction X). An avoidance region 16 is provided at an intersection of at least one signal line group 14 and the first signal line 11. That is, an avoidance region 16 is provided at an intersection of at least one second signal line 12 and the first signal line 11, and/or an avoidance region 16 is provided at an intersection of at least one third signal line 13 and the first signal line 11. In the avoidance region 16, the orthographic projection of the spacer 30 on the array substrate 100 does not overlap with the protruding structure 15 (the second protruding structure 15). The avoidance region 16 facilitates reducing the quantity of first protruding structures 151 and increasing the quantity of second protruding structures 152. By adjusting the quantity and density of avoidance regions 16, the contact density between the spacers 30 and the protruding structures 15 may be changed, that is, the density of orthographic projections of the main spacer regions 302 and the first secondary spacer regions 303 on the array substrate 100 may be adjusted.

In some embodiments, referring to FIGS. 7, 8 and 9, the signal line group 14 includes a second signal line 12; in other words, a second signal line 12 constitutes a signal line group 14. The signal line group 14 does not include a third signal line 13. In this case, the second signal line 12 controls connection between the first signal line 11 and the liquid crystal capacitor Clc as well as the storage capacitor Cst (the second electrode), that is, the second signal line 12 controls whether the first signal line 11 charges the liquid crystal capacitor Clc and the storage capacitor Cst. In this case, the liquid crystal capacitor Clc and the storage capacitor Cst may further be connected to a common voltage signal terminal COM, and the common voltage signal terminal COM is used to provide a continuous and stable voltage signal. For example, a signal line group 14 includes a second signal line 12, and the second signal line 12 controls ON/OFF relationships between the plurality of first signal lines 11 and second electrodes of a row of pixel regions 101. A plurality of first electrodes (common electrodes) of the plurality of sub-pixels may be connected to constitute an integral structure, thus forming the above-mentioned common voltage signal terminal COM. The common voltage signal terminal COM may be electrically connected to a signal line (e.g., a common voltage signal line) in a peripheral region.

The orthographic projection of the spacer 30 on the array substrate 100 covers the second signal line 12 in the signal line group 14. That is, within the length range of the spacer 30, the orthographic projection of the spacer 30 on the array substrate 100 covers the second signal line 12.

For example, a width, in the second direction Y, of the surface 301 of the spacer 30 close to the array substrate 100 may be D1, and a width of the second signal line 12 in the second direction Y is D2, where D1 is greater than D2. The alignment deviation between the array substrate 100 and the color filter substrate 200 is e. That is, during the assembling process of the array substrate 100 and the color filter substrate 200, the maximum alignment deviation between the array substrate 100 and the color filter substrate 200 in the second direction Y is e. In some embodiments, D1 is greater than or equal to D2+2e. That is, the orthographic projection of the spacer 30 on the array substrate 100 covers the second signal line 12 in the signal line group 14, and a distance between each of two edges of the second signal line 12 and a corresponding edge of two edges of the orthographic projection of the spacer 30 on the array substrate 100 is greater than or equal to e. In this way, when a slight deviation occurs during the assembling process of the array substrate 100 and the color filter substrate 200, a width of a portion of the orthographic projection of the spacer 30 on the array substrate 100 overlapping with the second signal line 12 is always D2. In this way, it may ensure that the spacer 30 may provide stable support for the liquid crystal layer, ensure that the liquid crystal layer may maintain a stable thickness, and in turn ensure the display effect of the display substrate.

In some embodiments, referring to FIGS. 7 and 8, a distance between the surface of the spacer 30 away from the second base 20 and the second base 20 is equal. Portions of the first signal line 11 overlapping with the signal line groups 14 form a plurality of protruding structures 15 that protrude toward the color filter substrate 200, and the surface of the spacer 30 away from the second base 20 abuts against a part of protruding structures 15. In this way, the spacer 30 cooperates with the first signal line 11 and the signal line group 14 to form different spacer regions of the spacer 30.

For example, portions of the surface of the spacer 30 away from the second base 20 that abut against the part of protruding structures 15 form main spacer regions 302. A portion of the spacer 30, whose orthographic projection on the array substrate 100 overlaps with the first signal line 11 or the signal line group 14 but does not overlap with the protruding structure 15, forms a first secondary spacer region 303. A portion of the spacer 30, whose orthographic projection on the array substrate 100 overlaps with a region of the array substrate 100 where the second signal line 12 is not located, forms a second secondary spacer region 304.

A surface of the protruding structure 15 close to the color filter substrate 200 abuts against the spacer 30. A distance between a surface, close to the color filter substrate 200, of a region other than the protruding structure 15 of the first signal line 11 (or the signal line group 14) and the spacer 30 is f; a distance between a portion of the array substrate 100 where the second signal line 12 is not located and the spacer 30 is g; and g>f>0. In this way, the spacer 30 cooperates with the first signal line 11 and the signal line group 14 to form the main spacer region 302, the first secondary spacer region 303, and the second secondary spacer region 304 which have a step difference.

In a normal state, the main spacer region 302 of the spacer 30 provides support for a thickness of the liquid crystal cell. When the display substrate is under pressure, the color filter substrate 200 is depressed toward the side close to the array substrate 100, and the first secondary spacer region 303 participates in supporting the thickness of the liquid crystal cell. When the display substrate is pressed strongly, the color filter substrate 200 is more depressed toward the array substrate 100, and at this time, the second secondary spacer region 304 starts to participate in supporting the thickness of the liquid crystal cell.

Referring to FIG. 7, the signal line group 14 is provided with a plurality of avoidance regions 16 in the length direction of the signal line group 14. An avoidance region 16 is provided at an intersection of at least one signal line group 14 and the first signal line 11. In the avoidance region 16, the orthographic projection of the spacer 30 on the array substrate 100 does not overlap with the protruding structure 15.

For example, the signal line group 14 includes a second signal line 12. In the non-avoidance region 17, the second signal line 12 extends in the length direction of the signal line group 14, i.e., extends in the first direction X. In the avoidance region 16, the second signal line 12 is bent and extends a certain distance in a direction perpendicular to the length direction of the signal line group 14, then extends in the length direction of the signal line group 14, and is bent back and extends to be colinear with the second signal line 12 in the non-avoidance region 17 after bypassing the protruding structure 15, and then continues to extend in the length direction of the signal line group 14. That is, in the avoidance region 16, the second signal line 12 protrudes in the second direction Y to avoid the spacer 30. In this way, the original main spacer region 302 in the avoidance region 16 is changed to the first secondary spacer region 303.

In some embodiments, in the avoidance region 16, the second signal line 12 is bent and extends in the direction perpendicular to the length direction of the signal line group 14 (the second direction Y) by a distance h, and a maximum alignment deviation between the array substrate 100 and the color filter substrate 200 in the second direction Y is e, where h is greater than or equal to e.

In some embodiments, referring to FIGS. 3 and 7, a dimension of the spacer 30 in the first direction X is greater than a distance between two adjacent first signal lines 11. In this way, it facilitates the spacer 30 abutting against a region where the first signal line 11 is located in the array substrate 100, thereby reducing the risk of contact between the spacer 30 and the pixel region 101, and in turn reducing the risk of the spacer scratching the alignment film in the pixel region 101, and reducing the risk of light leakage due to sliding of the spacer 30.

Next, the structure and size of the spacer 30 will be described by taking an example in which the signal line group 14 includes the second signal line 12 and the third signal line 13 and the signal line group 14 is disposed on a side of the first signal line 11 close to the first base 10. Of course, the embodiments of the present disclosure are not limited to this; it may be considered that the signal line group 14 consists of the second signal line 12; and it may be considered that the signal line group 14 is disposed on a side of the first signal line 11 away from the first base 10.

In some embodiments, referring to FIG. 3, the plurality of spacers 30 include at least one first spacer 31. An orthographic projection of the first spacer 31 on the array substrate 100 overlaps with at least thirteen first signal lines 11 and overlaps with one signal line group 14. FIG. 3 illustrates only three first signal lines as an example. At least eleven intersections among intersections of the at least thirteen first signal lines 11 and the one signal line group 14 are provided with avoidance regions 16.

In some embodiments, on average, one first spacer 31 is arranged for every twenty-four pixel regions 101 in the display substrate 1100. For example, in twenty-four pixel regions 101 arranged in two rows and twelve columns, one first spacer 31 crosses at least thirteen first signal lines 11 in a length direction of the first spacer 31, that is, the first spacer 31 crosses twelve pixel regions 101 in the length direction of the first spacer 31. An orthographic projection of the first spacer 31 on the array substrate 100 overlaps with thirteen first signal lines 11, and overlaps with one signal line group 14. At least eleven intersections among intersections of the thirteen first signal lines 11 and the one signal line group 14 are provided with avoidance regions 16. Thus, an area ratio between the main spacer regions 302 and the first secondary spacer regions 303 is close to 1:100. Based on this ratio, the main spacer region 302 and the first secondary spacer region 303 may satisfy the requirement of supporting the thickness of the liquid crystal cell and the requirement of no mura under external pressure.

Of course, the arrangement of the first spacer 31 and the arrangement of the avoidance regions 16 can be determined according to actual needs. For example, one first spacer 31 may be arranged for every 23, 24, 25, 26 or 27 pixel regions 101 on average. One first spacer 31 crosses 12, 13, 14, 15 or 16 first signal lines 11 in its length direction, that is, the first spacer 31 crosses 11, 12, 13, 14 or 15 pixel regions 101 in its length direction.

A quantity of avoidance regions 16 may be 11, 12, 13, 14 or 15, as long as a density of the orthographic projection of the main spacer region 302 on the array substrate 100 is in a range of 50 μm²/mm² to 300 μm²/mm², and a density of the orthographic projection of the first secondary spacer region 303 on the array substrate 100 is in a range of 5000 μm²/mm² to 20000 μm²/mm². The density of the orthographic projection of the main spacer region 302 (or the first secondary spacer region 303) on the array substrate 100 refers to: an area ratio between the orthographic projection of the main spacer region 302 (or the first secondary spacer region 303) on the array substrate 100 and the orthographic projection, on the first base 10, of the surface of the array substrate close to the color filter substrate.

In some embodiments, the density of the orthographic projection of the main spacer region 302 on the array substrate 100 is in a range of 50 μm²/mm² to 300 μm²/mm², which may ensure that the main spacer region 302 may provide good support for the thickness of the liquid crystal cell and is not easily prone to mura under external force. For example, the density of the orthographic projection of the main spacer region 302 on the array substrate 100 is in a range of 50 μm²/mm² to 100 μm²/mm²; or, the density of the orthographic projection of the main spacer region 302 on the array substrate 100 is in a range of 100 μm²/mm² to 170 μm²/mm²; or, the density of the orthographic projection of the main spacer region 302 on the array substrate 100 is in a range of 170 μm²/mm² to 300 μm²/mm². For example, the density of the orthographic projection of the main spacer region 302 on the array substrate 100 is 50 μm²/mm², 80 μm²/mm², 100 μm²/mm², 150 μm²/mm², 170 μm²/mm², 200 μm²/mm² or 300 μm²/mm², which will not be listed one by one in the embodiments of the present disclosure.

The density of the orthographic projection of the first secondary spacer region 303 on the array substrate 100 is in a range of 5000 μm²/mm² to 20000 μm²/mm². In this way, after the main spacer region 302 is pressed and deformed, the first secondary spacer region 303 may provide good support for the thickness of the liquid crystal cell. For example, the density of the orthographic projection of the first secondary spacer region 303 on the array substrate 100 is in a range of 5000 μm²/mm² to 8000 μm²/mm²; or, the density of the orthographic projection of the first secondary spacer region 303 on the array substrate 100 is in a range of 8000 μm²/mm² to 12000 μm²/mm²; or, the density of the orthographic projection of the first secondary spacer region 303 on the array substrate 100 is in a range of 12000 μm²/mm² to 20000 μm²/mm². For example, the density of the orthographic projection of the first secondary spacer region 303 on the array substrate 100 is 5000 μm²/mm², 6500 μm²/mm², 8000 μm²/mm², 10000 μm²/mm², 12000 μm²/mm², 16000 μm²/mm² or 20000 μm²/mm², which will not be listed one by one in the embodiments of the present disclosure.

It will be understood that, if the density of the orthographic projection of the main spacer region 302 on the array substrate 100 is too large (e.g., greater than 300 μm²/mm²), the second spacer 32 may have poor deformation performance and cannot effectively absorb external pressure through deformation, causing the display substrate to easily break or produce mura under pressure. If the density of the orthographic projection of the main spacer region 302 on the array substrate 100 is too small (e.g., less than 50 μm²/mm²), the second spacer 32 may have poor supporting effect, which is not conducive to maintaining the thickness of the liquid crystal layer. In addition, if the density of the orthographic projection of the first secondary spacer region 303 on the array substrate 100 is too large (e.g., greater than 20,000 μm²/mm²), the first secondary spacer region 303 may have poor deformation performance and cannot effectively absorb external pressure through deformation, causing the display substrate to easily break or produce mura under pressure. If the density of the orthographic projection of the first secondary spacer region 303 on the array substrate 100 is too small, the second spacer 32 may have poor supporting effect, which is not conducive to maintaining the thickness of the liquid crystal layer. In the embodiments of the present disclosure, the density of the orthographic projection of the main spacer region 302 on the array substrate 100 is in a range of 50 μm²/mm² to 300 μm²/mm², and the density of the orthographic projection of the first secondary spacer region 303 on the array substrate 100 is in a range of 5000 μm²/mm² to 20000 μm²/mm², which may ensure that the main spacer region 302 may provide good support for the thickness of the liquid crystal cell and is not easily prone to mura under external force.

In some embodiments, the first spacer 31 is connected to a portion of the protruding structure 15, and a distance between a surface of the first spacer 31 away from the second base 20 and the second base 20 is equal.

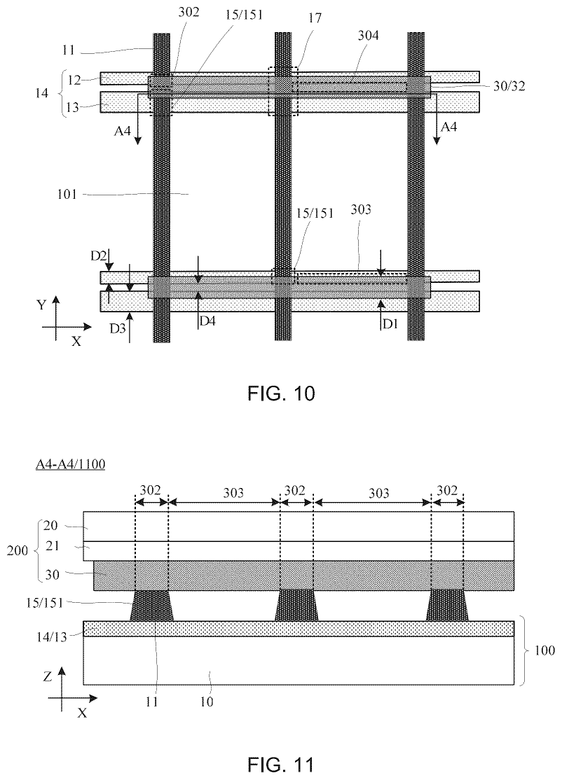

In some embodiments, referring to FIGS. 10 and 11, the plurality of spacers 30 may further include a plurality of second spacers 32. An orthographic projection of the second spacer 32 on the array substrate 100 overlaps with three first signal lines 11, and overlaps with one signal line group 14. The second spacer 32 abuts against protruding structures 15 formed at intersections of the three first signal lines 11 and the one signal line group 14. That is, the intersections of the three first signal lines 11 and the one signal line group 14 are all non-avoidance regions 17.

A density of the main spacer region 302 formed by the second spacer 32 (a ratio of an area of the main spacer region 302 to a total area of the spacer) is large. Under the condition of the same distribution density, the external force required for deformation of the second spacer 32 is large. Based on this, the density of the main spacer regions 302 may be adjusted by adjusting (e.g., reducing) the density and quantity of the second spacers 32 in the display substrate, so as to satisfy that the density of orthographic projections of the main spacer regions 302 on the array substrate 100 is in a range of 50 μm²/mm² to 300 μm²/mm².

For example, when the plurality of spacers 30 only include the second spacers 32, one second spacer 32 may be arranged for every 25 to 40 pixel regions 101. Of course, the arrangement density and distribution of the second spacers 32 are not limited, which may be flexibly set according to needs. In addition, the display substrate may include the first spacers 31 and the second spacers 32, and the distribution density of the first spacers 31 and the distribution density of the second spacers 32, as well as the relative position between the first spacers 31 and the second spacers 32, etc., may be flexibly set according to needs, as long as the density of the orthographic projections, on the array substrate 100, of the main spacer regions 302 formed by the first spacer 31 and the second spacer 32 is in a range of 50 μm²/mm² to 300 μm²/mm², and the density of the orthographic projection of the first secondary spacer region 303 on the array substrate 100 is in a range of 5000 μm²/mm² to 20000 μm²/mm².

In some embodiments, referring to FIGS. 10 and 11, a distance between a surface of the second spacer 32 away from the second base 20 and the second base 20 is equal. Overlapping portions of the first signal lines 11 and the signal line groups 14 form a plurality of protruding structures 15 protruding toward the color filter substrate 200. A surface of the spacer 30 away from the second base 20 abuts against a part of protruding structures 15. In this way, the second spacer 32 may cooperate with the first signal line 11 and the signal line group 14 to form different spacer regions in the second spacer 32.

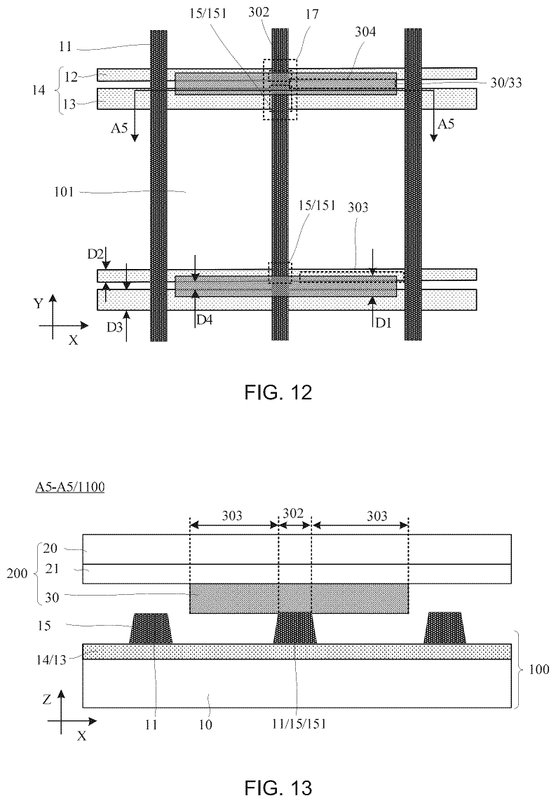

In some embodiments, referring to FIGS. 12 and 13, the plurality of spacers 30 further include at least one third spacer 33. An orthographic projection of a third spacer 33 on the array substrate 100 overlaps with one first signal line 11, and overlaps with one signal line group 14. The third spacer 33 abuts against a protruding structure 15 formed at an intersection of the one first signal line 11 and the one signal line group 14.

An area ratio between the main spacer region 302 and the first secondary spacer region 303 formed by the third spacer 33 is reduced (closer to 1:100), which is conducive to reducing the density of the main spacer region 302 (a ratio of an area of the main spacer region 302 to a total area of the spacer) and increasing the density of the first secondary spacer regions 303. Based on this, the density of the main spacer region 302 may be adjusted by adjusting the density and quantity of the third spacer(s) 33 in the display substrate, so that the third spacer(s) 33 satisfy that the density of orthographic projection of the main spacer region 302 on the array substrate 100 is in a range of 50 μm²/mm² to 300 μm²/mm², and the density of the orthographic projection of the first secondary spacer region 303 on the array substrate 100 is in a range of 5000 μm²/mm² to 20000 μm²/mm². For example, the size of the third spacer 33 may be reduced so that both ends of the third spacer 33 do not overlap with a first signal line 11; and in order to increase the density of the first secondary spacer region 303, the ends of the third spacer 33 may be made as close as possible to first signal lines 11 at both ends of the third spacer 33.

For example, the plurality of spacers 30 of the display substrate may include only the third spacer(s) 33. In this case, one third spacer 33 may be arranged for every 15 to 30 pixel regions 101. Of course, the arrangement density and distribution of the third spacer(s) 33 are not limited, which may be flexibly set according to needs. In addition, the display substrate may include the second spacers 32 and the third spacer(s) 33, and the distribution density of the second spacers 32 and the distribution density of the third spacer(s) 33 as well as the relative position between the second spacers 32 and the third spacer(s) 33, etc., may be flexibly set according to needs, as long as the density of the orthographic projections, on the array substrate 100, of the main spacer regions 302 formed by the second spacers 32 and the third spacer(s) 33 is in a range of 50 μm²/mm² to 300 μm²/mm², and the density of the orthographic projection of the first secondary spacer region 303 on the array substrate 100 is in a range of 5000 μm²/mm² to 20000 μm²/mm².

In some embodiments, referring to FIGS. 12 and 13, a distance between a surface of the third spacer 33 away from the second base 20 and the second base 20 is equal. Portions of the first signal line 11 overlapping with the signal line group 14 form multiple protruding structures 15 protruding toward the color filter substrate 200, and the surface of the third spacer 33 away from the second base 20 abuts against a part of protruding structures 15. A dimension of the third spacer 33 in the first direction X may be greater than a distance between two adjacent first signal lines 11. In this way, the third spacer 33 may cooperate with the first signal line 11 and the signal line group 14 to form different spacer regions in the third spacer 33.

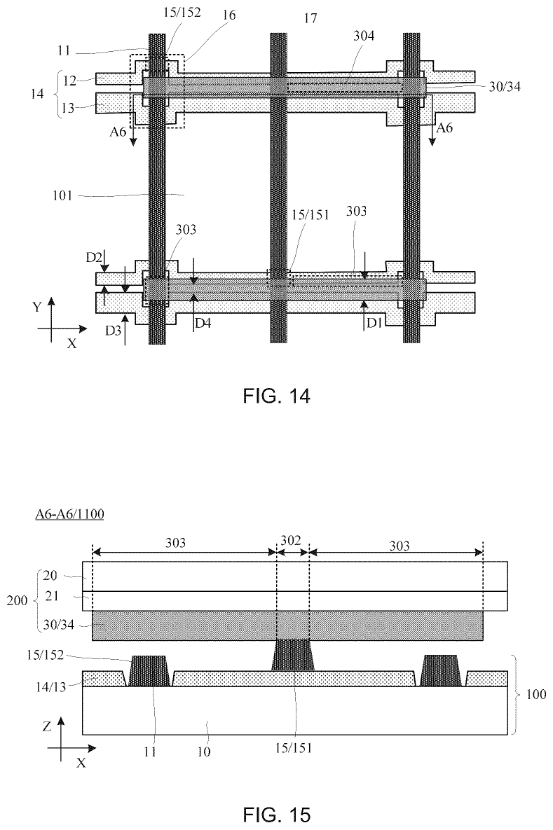

In some embodiments, referring to FIGS. 14 and 15, the plurality of spacers 30 include at least one fourth spacer 34. An orthographic projection of a fourth spacer 34 on the array substrate 100 overlaps with three first signal lines 11, and overlaps with one signal line group 14. Avoidance regions 16 are provided at intersections of two first signal lines 11 among the three first signal lines 11 and the signal line group 14. For example, as shown in FIG. 14, avoidance regions 16 are provided at intersections of two first signal lines 11 located on two sides among the three first signal lines 11 and the signal line group 14, and a non-avoidance region 17 is provided at an intersection of a first signal line 11 located in a middle among the three first signal lines 11 and the signal line group 14. The fourth spacer 34 abuts against a protruding structure 15 (a first protruding structure 151) formed at an intersection of one first signal line 11 among the three first signal lines 11 (the first signal line 11 located in the middle) and the signal line group 14.

An area ratio between the main spacer region 302 and the first secondary spacer region 303 formed by the fourth spacer 34 is reduced (closer to 1:100), which is conducive to reducing an area proportion of the main spacer regions 302 and increasing an area proportion of the first secondary spacer regions 303. Based on this, the density of the main spacer region 302 formed by the fourth spacer 34 and the density of the first secondary spacer region 303 formed by the fourth spacer 34 may be adjusted by adjusting the density and quantity of the fourth spacer(s) 34 in the display substrate, so that the fourth spacer(s) 34 satisfy that the density of orthographic projection of the main spacer region 302 on the array substrate 100 is in a range of 50 μm²/mm² to 300 μm²/mm², and the density of the orthographic projection of the first secondary spacer region 303 on the array substrate 100 is in a range of 5000 μm²/mm² to 20000 μm²/mm².

In some embodiments, referring to FIGS. 14 and 15, a distance between a surface of the fourth spacer 34 away from the second base 20 and the second base 20 is equal. Portions of the first signal line 11 overlapping with the signal line group 14 form multiple protruding structures 15 protruding toward the color filter substrate 200, and the surface of the fourth spacer 34 away from the second base 20 abuts against a part of protruding structures 15. A dimension of the fourth spacer 34 in the first direction X may be greater than a distance between two adjacent first signal lines 11. In this way, the fourth spacer 34 may cooperate with the first signal line 11 and the signal line group 14 to form different spacer regions in the fourth spacer 34.

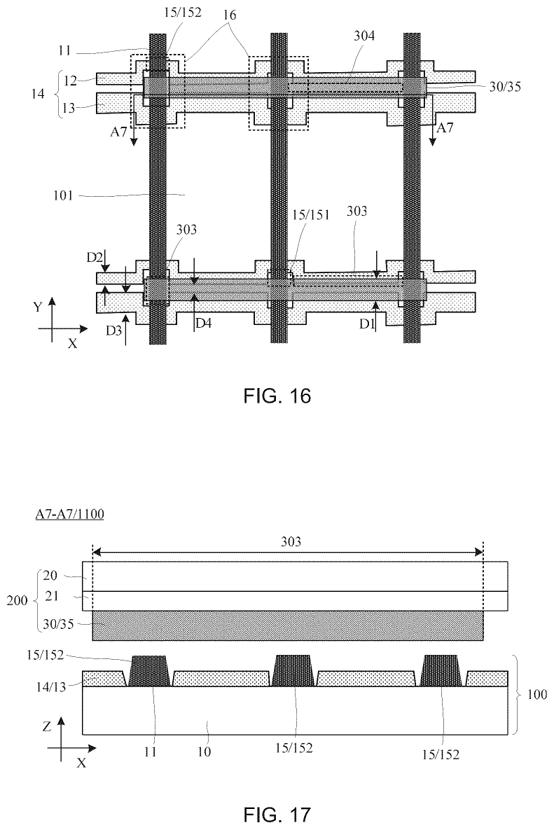

In some embodiments, referring to FIGS. 16 and 17, the plurality of spacers 30 include at least one fifth spacer 35. An orthographic projection of a fifth spacer 35 on the array substrate 100 overlaps with three first signal lines 11, and overlaps with one signal line group 14. An avoidance region 16 is provided at each intersection of the three first signal lines 11 and the one signal line group 14. The fifth spacer 35 is not in contact with protruding structures 15 (second protruding structures 152) formed at the intersections of the three first signal lines 11 and the one signal line group 14. In other words, a region of the orthographic projection of the fifth spacer 35 on the array substrate 100 overlapping with the first signal line 11 or the signal line group 14 forms a first secondary spacer region 303, and the fifth spacer 35 is not used to form a main spacer region 302.

The fifth spacer 35 does not form the main spacer region 302, and is only used to form the first secondary spacer region 303. The fifth spacer(s) 35 are used to increase the density of the orthographic projection of the first secondary spacer region 303 on the array substrate 100. Thereby, the density of the orthographic projection of the first secondary spacer region 303 on the array substrate 100 is in a range of 5000 μm²/mm² to 20000 μm²/mm².

For example, the fifth spacer(s) 35 may be used in conjunction with at least one of the first spacers 31, the second spacers 32, the third spacer(s) 33 or the fourth spacer(s) 34. That is, in the case where the display substrate 1100 includes the fifth spacer(s) 35, the display substrate 1100 may further include at least one of the first spacers 31, the second spacers 32, the third spacer(s) 33 or the fourth spacer(s) 34. For example, the plurality of spacers 30 of the display substrate 1100 include a plurality of second spacers 32 and a plurality of fifth spacers 35; alternatively, the plurality of spacers 30 include a plurality of third spacers 33 and a plurality of fifth spacers 35; alternatively, the plurality of spacers 30 include a plurality of second spacers 32, a plurality of third spacers 33 and a plurality of fifth spacers 35. The embodiments of the present disclosure do not list the combinations of the above various spacers one by one.

In some embodiments, referring to FIGS. 16 and 17, a distance between a surface of the fifth spacer 35 away from the second base 20 and the second base 20 is equal. Portions of the first signal line 11 overlapping with the signal line group 14 form multiple protruding structures 15 protruding toward the color filter substrate 200, and the surface of the fifth spacer 35 away from the second base 20 does not abut against the protruding structures 15. A dimension of the fifth spacer 35 in the first direction X may be greater than a distance between two adjacent first signal lines 11. In this way, the fifth spacer 35 may cooperate with the first signal line 11 and the signal line group 14 to form different spacer regions in the fifth spacer 35.

The second spacer 32, the third spacer 33, the fourth spacer 34 and the fifth spacer 35 have smaller sizes in the first direction X. After the array substrate and the color film substrate form a liquid crystal cell, more gaps are formed between the second spacer 32, the third spacer 33, the fourth spacer 34 and the fifth spacer 35, which facilitates the flow of liquid crystals in the liquid crystal cell, that is, it is conducive to filling liquid crystals in the liquid crystal cell.

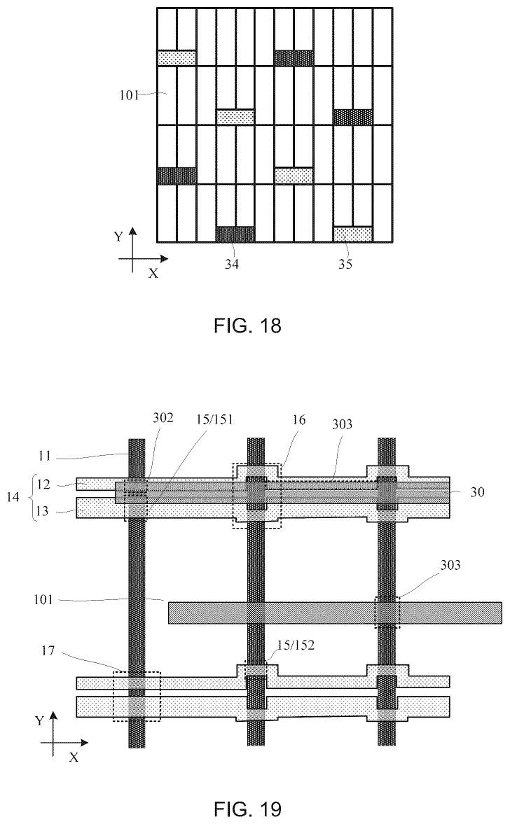

In some embodiments, referring to FIG. 18, the plurality of spacers 30 of the display substrate 1100 include a plurality of fourth spacers 34 and a plurality of fifth spacers 35, and four fourth spacers 34 and four fifth spacers 35 are arranged for every forty-eight pixel regions 101 at least. That is to say, the plurality of spacers 30 consist of a plurality of fourth spacers 34 and a plurality of fifth spacers 35. The density of the orthographic projection of the main spacer region 302 on the array substrate 100 may be adjusted by adjusting the quantity and distribution density of the fourth spacers 34, and the density of the orthographic projection of the first secondary spacer region 303 on the array substrate 100 may be adjusted by adjusting the quantity and distribution density of the fifth spacers 35, so that a contact density ratio between the main spacer regions 302 and the first secondary spacer regions 303 is close to 1:100. The main spacer regions 302 and the first secondary spacer regions 303 with this contact density ratio may not only support the thickness of the liquid crystal cell, but also meet the requirement of no mura under external pressure.

It will be noted that in the embodiments of the present disclosure, FIG. 18 is only used to illustrate the arrangement manner and arrangement density of the fourth spacers 34 and the fifth spacers 35, and is not used to show the corresponding relationship and projection relationship between the fourth spacers 34 and the pixel regions 101 and the corresponding relationship and projection relationship between the fifth spacers 35 and the pixel regions 101.

In some embodiments, referring to FIG. 18, in the case where the color filter substrate 200 includes a plurality of fourth spacers 34 and a plurality of fifth spacers 35. The plurality of fourth spacers 34 and the plurality of fifth spacers 35 are arranged in rows in the first direction X, and a row includes multiple fourth spacers 34 and multiple fifth spacers 35 that are alternately arranged; and/or the plurality of fourth spacers 34 and the plurality of fifth spacers 35 are arranged in columns in the second direction Y, and a column includes fourth spacers 34 and fifth spacers 35 that are alternately arranged. In this way, it is conducive to improving the distribution uniformity of the main spacer regions 302 and the first secondary spacer regions 303, improving the stress uniformity between the array substrate 100 and the color filter substrate 200, and reducing the risk of excessive local stress between the array substrate 100 and the color filter substrate 200.

It will be noted that, in some embodiments, the color filter substrate 200 may include at least one of the first spacers 31, the second spacers 32, the third spacer(s) 33 or the fourth spacer(s) 34. In addition, the fifth spacer(s) 35 cannot form the main spacer region 302. Therefore, the fifth spacer(s) 35 need to be used in conjunction with at least one of the first spacers 31, the second spacers 32, the third spacer(s) 33, or the fourth spacer(s) 34. The above various possible combinations are not listed one by one in the embodiments of the present disclosure.

In some embodiments, the spacer 30 (the first spacer 31, the second spacer 32, the third spacer 33, the fourth spacer 34, or the fifth spacer 35) crosses over multiple first signal lines 11 in the length direction of the spacer 30. As shown in FIG. 19, when the spacer 30 has a large displacement in the second direction Y, for example, when the spacer 30 is displaced in the second direction Y to not overlap with the signal line group 14, the first signal line 11 can still support the spacer 30. That is, when the spacer 30 has a large displacement in the second direction Y, the spacer 30 will lose the main spacer region 302 and the first secondary spacer region 303 formed by overlapping with the signal line group 14, but will keep the first secondary spacer region 303 formed by overlapping with the first signal line 11. Therefore, the large displacement of the spacer 30 in the second direction Y will not cause scratches on a part of the alignment film located in the pixel region 101 on the array substrate 100.

For example, the arrangement of the spacers 30 may be determined according to requirements. For example, one main spacer region 302 and six to twelve first secondary spacer regions 303 may be arranged for twenty-four pixel regions 101 that are arranged in three rows and eight columns; alternatively, one main spacer region 302 and six to twelve first secondary spacer regions 303 are arranged for twenty-four pixel regions 101 that are arranged in four rows and six columns, and so on, as long as the spacers 30 are evenly arranged on a whole surface and the contact density ratio between the main spacer regions 302 and the first secondary spacer regions 303 is close to 1:100. Of course, the arrangement of the spacers 30 and the arrangement of the avoidance regions 16 can be determined according to actual needs.

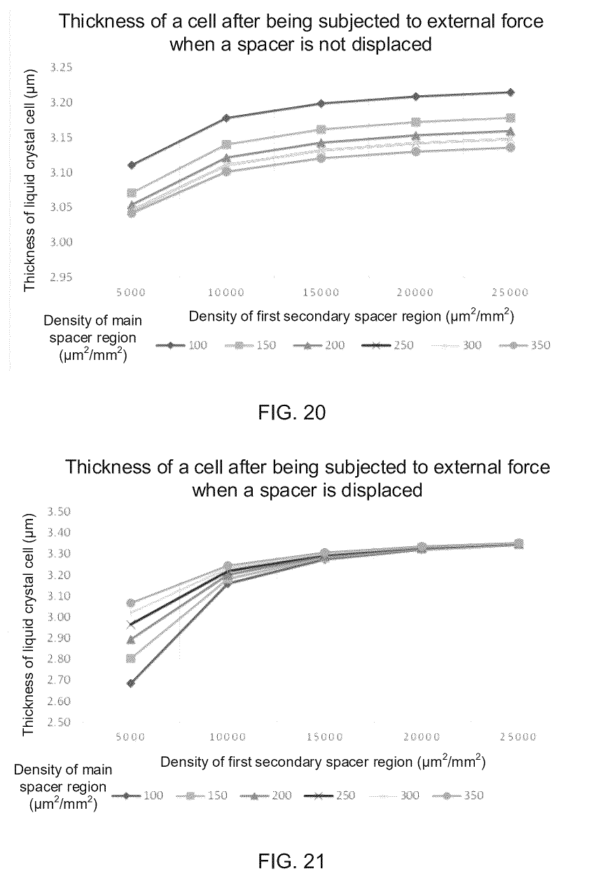

FIGS. 20 and 21 shows the thickness of the liquid crystal cell of the display substrates, subjected to external force, having the main spacer regions 302 and the first secondary spacer regions 303 which have different contact densities when the spacer 30 is not displaced and when spacer 30 is displaced.

In FIGS. 20 and 21, the horizontal axis represents the contact density (μm²/mm²) of the first secondary spacer region 303, and the vertical axis represents the thickness (μm) of the liquid crystal cell. Six lines from top to bottom in FIG. 20 represent the contact densities of the main spacer region 302 as 100 μm²/mm², 150 μm²/mm², 200 μm²/mm², 250 μm²/mm², 300 μm²/mm², and 350 μm²/mm², respectively. Six lines from top to bottom in FIG. 21 represent the contact densities of the main spacer region 302 as 350 μm²/mm², 300 μm²/mm², 250 μm²/mm², 200 μm²/mm², 150 μm²/mm², and 100 μm²/mm², respectively. It is obvious that as the contact density of the first secondary spacer region 303 is increased, the thickness of the liquid crystal cell after the display substrate is subjected to external force is gradually increased. In a case where the contact density of the main spacer region 302 is 200 μm²/mm² and the contact density of the first secondary spacer region 303 is 20000 μm²/mm², the spacer 30 may provide good support for the thickness of the liquid crystal cell.

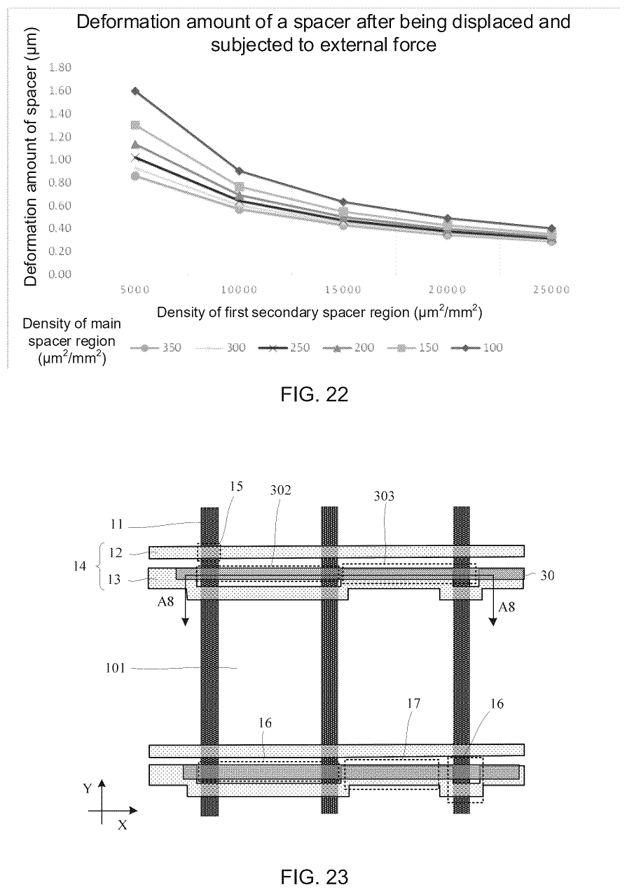

FIG. 22 shows the deformation amount of the spacer 30 when the spacer 30 is displaced after the display substrates, having the main spacer regions 201 and the first secondary spacer regions 202 which have different contact densities, is subjected to external force. In FIG. 22, the horizontal axis represents the contact density (μm²/mm²) of the first secondary spacer region 202, and the vertical axis represents the deformation amount (μm) of the spacer. Six lines from top to bottom in FIG. 22 represent the contact densities of the main spacer region 302 as 100 μm²/mm², 150 μm²/mm², 200 μm²/mm², 250 μm²/mm², 300 μm²/mm², and 350 μm²/mm², respectively. The thickness of the first signal line 11 is generally in a range from 0.5 μm to 0.7 μm, and the thickness of the signal line group 14 is in a range from 0.5 μm to 0.7 μm. It may be obvious that in a case where the contact density of the first secondary spacer region 303 is greater than 15000 μm²/mm² and the contact density of the main spacer region 302 is greater than 150 μm²/mm², the deformation amount of the spacer 30 is obviously less than the thickness of the first signal line 11. In this case, the displacement of the spacer 30 will not cause scratches on the alignment film.

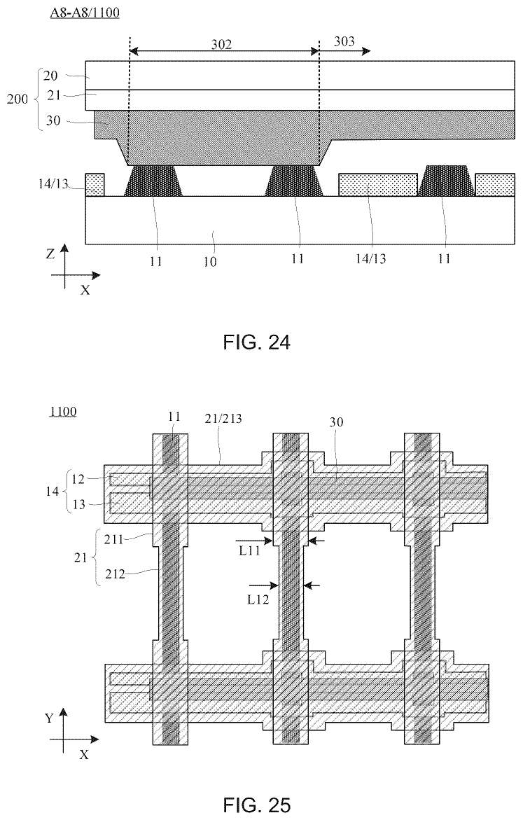

In some embodiments, referring to FIGS. 23 and 24, the orthographic projection of the spacer 30 on the array substrate 100 partially overlaps with the signal line group 14. A distance between the surface of the spacer 30 away from the second base 20 and the second base 20 is not uniform. The spacer 30 includes a main spacer region 302 having a first thickness and a first secondary spacer region 303 having a second thickness, the first thickness being greater than the second thickness. The orthographic projection of the main spacer region 302 on the array substrate 100 overlaps with the first signal line 11, and the orthographic projection of the main spacer region 302 on the array substrate does not overlap with the signal line group 14. The orthographic projection of the main spacer region 302 on the array substrate 100 covers at least two first signal lines 11 in the length direction of the spacer 30. A part of the orthographic projection of the first secondary spacer region 303 on the array substrate 100 overlaps with the first signal line 11, and a part of the orthographic projection of the first secondary spacer region 303 on the array substrate 100 overlaps with the signal line group 14.

With continued reference to FIGS. 23 and 24, the signal line group 14 is provided with a plurality of avoidance regions 16 in the length direction thereof. An intersection of at least one signal line group 14 and the first signal line 11 is provided with an avoidance region 16. In the avoidance region 16, the signal line group 14 avoids a region where the spacer 30 overlaps with the first signal line 11. That is, the spacer 30, the signal line group 14 and the first signal line 11 do not overlap at the same time. Moreover, a position of the orthographic projection of the main spacer region 302 on the array substrate 100 is also provided with an avoidance region 16; and in the avoidance region 16, the signal line group 14 avoids a coverage of the orthographic projection of the main spacer region 302 on the array substrate 100. The maximum alignment deviation between the array substrate 100 and the color filter substrate 200 in the second direction Y is e; in the avoidance region 16, a distance between the signal line group 14 and the region where the spacer 30 overlaps with the first signal line 11 is greater than e; and in the avoidance region 16, a distance between the signal line group 14 and the region covered by the orthographic projection of the main spacer region 302 on the array substrate 100 is greater than e. That is, in the avoidance region 16, the orthographic projection of the first secondary spacer region 303 on the array substrate 100 overlaps with the first signal line 11; and in the non-avoidance region 17, the orthographic projection of the first secondary spacer region 303 on the array substrate 100 overlaps with the signal line group 14.

In some embodiments, referring to FIG. 25, an orthographic projection of the black matrix 21 on the array substrate 100 covers the spacers 30, the first signal lines 11, and the signal line groups 14. The color filter substrate 200 further includes a black matrix 21, the black matrix 21 is disposed between the second base 20 and the spacers 30, and the orthographic projection of the black matrix 21 on the array substrate 100 covers the orthographic projections of the spacers 30 on the array substrate 100, and covers the first signal lines 11 and the signal line groups 14. For example, the orthographic projection of the black matrix 21 on the array substrate 100 covers a region other than the pixel regions 101. The black matrix 21 is further configured to separate different pixel regions 101, so as to reduce the risk of cross-color between different pixel regions and avoid affecting the final display effect. The black matrix 21 may also prevent the spacers 30 from slipping and causing abnormal display of the panel, and shield the scratched distance.

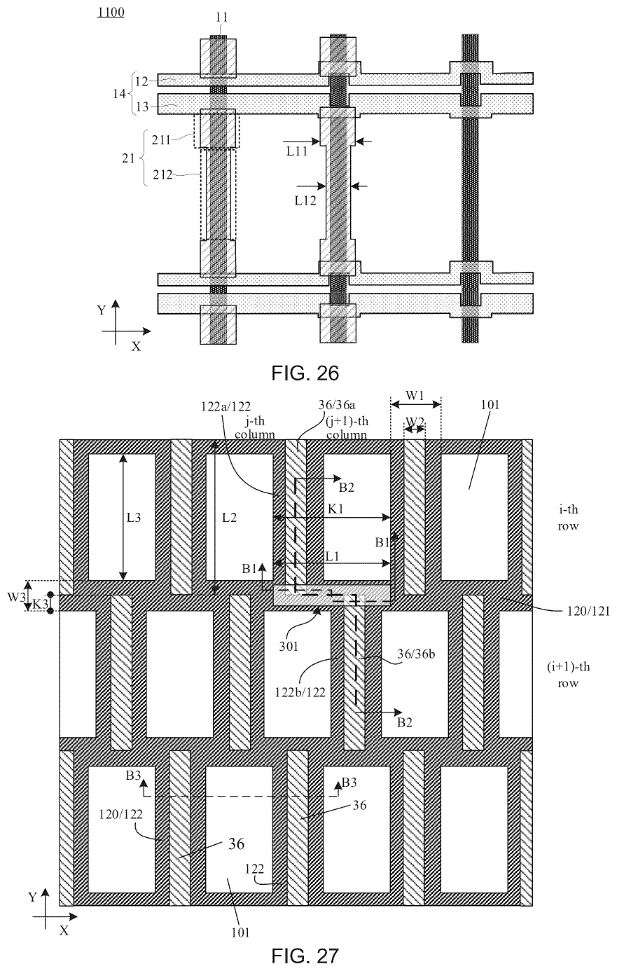

In some embodiments, referring to FIGS. 25 and 26, the black matrix 21 further includes a first portion 211 and a second portion 212. An orthographic projection of the first portion 211 on the array substrate 100 covers a portion of the first signal line 11 close to the signal line group 14. The second portion 212 is located on a side of the first portion 211 away from the signal line group 14 in an extending direction of the first signal line 11, and the second portion 212 is connected to the first portion 211. A dimension L11 of the first portion 211 in the first direction X is greater than a dimension L12 of the second portion 212 in the first direction X, that is, L11>L12. When the display substrate is pressed by external force, the spacer 30 may slide and displace. For example, the spacer may abut against a region of a portion of the signal line group 14 close to the first signal line 11 and scratch the alignment film in the region. Since L11>L12, it is conducive to increasing the dimension of the first portion 211 in the first direction X, so that the first portion 211 can shield the above-mentioned region and reduce the risk of light leakage in this region.

It will be understood that in some actually manufactured display substrates, the array substrate may further include a planarization layer located on a side, away from the first base, of the first signal lines and the signal line groups. In this case, a height difference caused by the thicknesses of the first signal line and the signal line group cannot be formed in the surface of the array substrate, that is, a protruding structure cannot be formed in the region where the first signal line and the signal line group overlap. For example, the array substrate may include a first conductive layer (e.g., a film layer where the first signal lines (or the signal line groups) are located), a buffer layer, a semiconductor layer, a gate insulating layer, a second conductive layer (e.g., a film layer where the signal line groups (or the first signal lines) are located), a first insulating layer, a first electrode layer, a second insulating layer, a second electrode layer, and a third insulating layer, which are sequentially disposed on the first base. At least one of the first insulating layer and the second insulating layer may be a planarization layer. In the case where the display substrate includes the array substrate, how to arrange spacers to prevent the spacers from scratching the alignment film in the pixel regions and to reduce the fabrication cost of the spacers with different thicknesses is an important technical problem faced in the related art.

In order to solve the above technical problem, some embodiments of the present disclosure further provide a display substrate. Referring to FIGS. 27, 28 and 29, the display substrate includes an array substrate 100 and a color filter substrate 200. The array substrate includes a first base substrate 110 and sub-spacers 36 disposed on a side of the first base substrate 110. The sub-spacers 36 may be disposed on a side of the first base substrate 110 facing the color filter substrate 200. The sub-spacer 36 is located between two adjacent pixel regions 101 in the first direction X, and the sub-spacer 36 extends in the second direction Y.

It will be noted that the first base substrate 110 may include the first base and a plurality of film layers being disposed on the first base and including at least one planarization layer, and forms a substantially planar surface structure. For example, the first base substrate 110 includes the first base, and a first conductive layer, a buffer layer, a semiconductor layer, a gate insulating layer, a second conductive layer, a first insulating layer, a first electrode layer, a second insulating layer, a second electrode layer, and a third insulating layer, which are sequentially disposed in a direction away from the first base. Of course, the structure of the first base substrate 110 is not limited thereto, and any other substrate including at least one planarization layer and capable of forming a substantially planar surface may be considered.

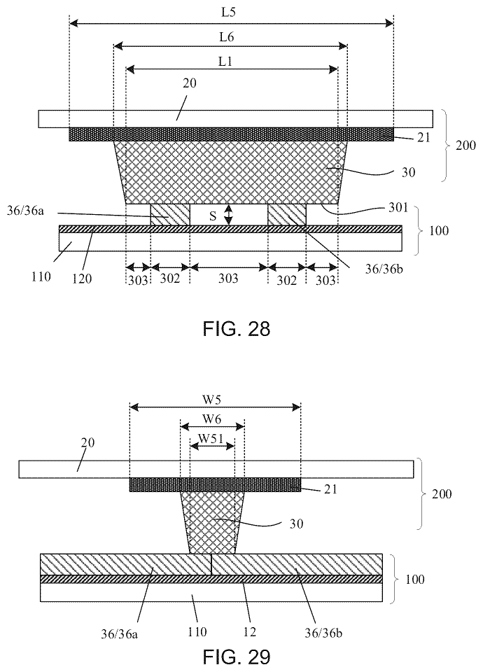

As shown in FIGS. 27 and 28, the color filter substrate 200 includes the second base 20 and spacers 30 disposed on the second base 20. The spacers 30 are disposed on a side of the second base 20 facing the array substrate 100, and the spacers 30 extend in the first direction X. A spacer 30 abuts against a sub-spacer 36 corresponding to an i-th row of pixel regions 101, and the spacer 30 abuts against a sub-spacer 36 corresponding to an (i+1)-th row of pixel regions 101, where i is a natural number greater than or equal to 1. That is to say, for the same spacer 30, a surface 301 (referred to as a first surface 301 below) of the spacer 30 close to the array substrate 100 is in contact with a surface, close to the color filter substrate 200, of the sub-spacer 36 corresponding to the i-th row of pixel regions 101 (i.e., an upper surface of the sub-spacer 36), and the first surface 301 is in contact with an upper surface of the sub-spacer 36 corresponding to the (i+1)-th row of pixel regions 101. In FIG. 27, the spacer 30 abuts against the sub-spacer 36a corresponding to the i-th row of pixel regions 101, and the spacer 30 abuts against the sub-spacer 36b corresponding to the (i+1)-th row of pixel regions 101.

In the embodiments of the present disclosure, the sub-spacers 36 are formed on a side of the first base substrate 110 close to the color filter substrate 200. A sub-spacer 36 is located between two adjacent pixel regions 101 in the first direction X, and the sub-spacer 36 extends in the second direction Y. In this way, the sub-spacer 36 can form a step difference structure in the surface of the array substrate 100 that is protruding compared to other parts of the surface. That is, the sub-spacer 36 can form a protrusion equivalent to a protruding structure. The spacer 30 extends in the first direction X, and the spacer 30 abuts against the sub-spacers 36 respectively corresponding to two adjacent rows of pixel regions 101 (the spacer 30 is in contact with both the sub-spacer 36a and the sub-spacer 36b at the same time). In this way, there is a gap S between the spacer 30 and a surface of the array substrate 100 located in the pixel region 101. Even if the display substrate slides due to external force, the spacer 30 may still abut against the sub-spacer 36, which reduces the risk of the spacer 30 in contact with the alignment film in the pixel region 101, and in turn mitigates the problem of the alignment film in the pixel region 101 being scratched, and may effectively prevent the light leakage problem caused by the scratched alignment film.

For example, an area that the spacer 30 abuts against the sub-spacer 36a corresponding to the i-th row of pixel regions 101 is S1, an area that the spacer 30 abuts against the sub-spacer 36b corresponding to the (i+1)-th row of pixel regions 101 is S2, and a total area that the spacer 30 abuts against the sub-spacers 36 may be S1+S2.

In the display substrate provided in the embodiments of the present disclosure, when an alignment deviation between the color filter substrate 200 and the array substrate 100 causes an alignment deviation between the spacer 30 and the sub-spacers 36 in the second direction Y, the spacer 30 abuts against both the sub-spacer 36a corresponding to the i-th row of pixel regions 101 and the sub-spacer 36b corresponding to the (i+1)-th row of pixel regions 101 at the same time, and the sub-spacers 36 extend in the second direction Y. Therefore, as shown in FIG. 27, when the spacer 30 moves upward relative to the sub-spacers 36, the contact area between the spacer 30 and the sub-spacer 36a increases by ΔS1, and the contact area between the spacer 30 and the sub-spacer 36b decreases by ΔS2, where ΔS1=ΔS2, and the total contact area between the spacer 30 and the sub-spacers 36 remains S1+S2; when the spacer 30 moves downward relative to the sub-spacers 36, the contact area between the spacer 30 and the sub-spacer 36a decreases by ΔS3, and the contact area between the spacer 30 and the sub-spacer 36b increases by ΔS4, where ΔS3=ΔS4, and the total contact area between the spacer 30 and the sub-spacers 36 remains S1+S2. Therefore, in the display substrate provided in the embodiments of the present disclosure, when the spacer 30 and the sub-spacer 36 have an alignment deviation in the second direction Y, the total contact area between the spacer 30 and the sub-spacers 36 can remain unchanged, which ensures that the total contact area between the spacer 30 and the sub-spacers 36 is not affected by the alignment deviation, ensures the supporting strength of the spacers 30 and the sub-spacers 36, and is conducive to maintaining the uniformity of the thickness of the liquid crystal cell.

As shown in FIG. 27, in a row of pixel regions 101, a sub-spacer 36 is located between two adjacent pixel regions 101. Therefore, a row of pixel regions 101 may correspond to multiple sub-spacers 36. The spacer 30 may abut against one sub-spacer 36 corresponding to the i-th row of pixel regions 101, and the spacer 30 may abut against one sub-spacer 36 corresponding to the (i+1)-th row of pixel regions 101. For example, in FIG. 27, the first surface 301 abuts against the sub-spacer 36a corresponding to the i-th row of pixel regions 101, and the first surface 301 abuts against the sub-spacer 36b corresponding to the (i+1)-th row of pixel regions 101.

In some embodiments, as shown in FIG. 27, in a row of pixel regions 101, a sub-spacer 36 is located between two adjacent pixel regions 101. Therefore, a row of pixel regions 101 may correspond to multiple sub-spacers 36. The spacer 30 may abut against one sub-spacer 36 corresponding to the i-th row of pixel regions 101, and the spacer 30 may abut against one sub-spacer 36 corresponding to the (i+1)-th row of pixel regions 101. For example, in FIG. 27, the first surface 301 abuts against the sub-spacer 36a corresponding to the i-th row of pixel regions 101, and the first surface 301 abuts against the sub-spacer 36b corresponding to the (i+1)-th row of pixel regions 101.

In an example, as shown in FIG. 27, two adjacent rows of pixel regions 101 are arranged in a staggered manner, and two adjacent rows of sub-spacers 36 are arranged in a staggered manner. The sub-spacer 36a and the sub-spacer 36b that abut against the same spacer 30 are two sub-spacers 36 adjacent to each other in the first direction X in two adjacent rows of sub-spacers 36. That is, the sub-spacer 36a and the sub-spacer 36b are adjacent to each other in the first direction X.

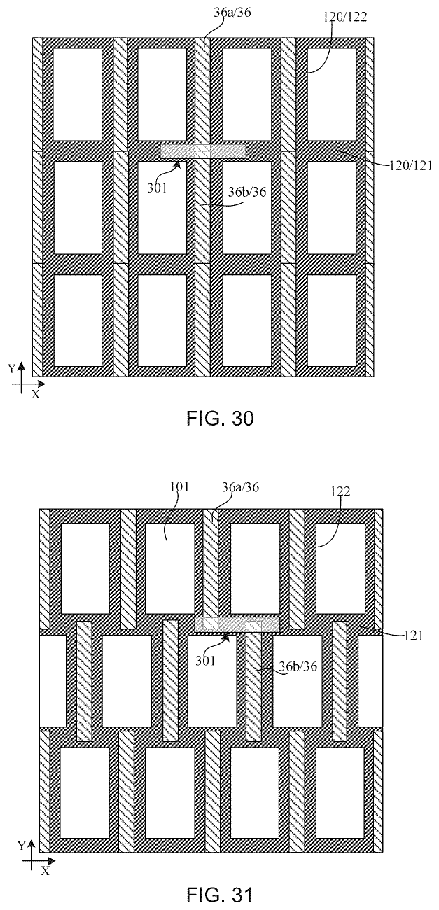

In some embodiments, referring to FIG. 30, the display substrate may include a plurality of pixel regions 101, and the plurality of pixel regions 101 are arranged in a plurality of rows and a plurality of columns. The two sub-spacers 36 abutting against the same spacer 30 are located between the same two columns of pixel regions 101. The sub-spacer 36a and the sub-spacer 36b abutting against the same spacer 30 may be located between the same two columns of pixel regions 101, and both the sub-spacer 36a and the sub-spacer 36b are located between a j-th column of pixel regions 101 and a (j+1)-th column of pixel regions 101.

In some embodiments, referring to FIGS. 27, 30 and 31, a gap between the sub-spacer 36 corresponding to the i-th row of pixel regions 101 and the sub-spacer 36 corresponding to the (i+1)-th row of pixel regions 101 in the second direction Y is less than or equal to 0. That is, the gap between the sub-spacer 36a and the sub-spacer 36b in the second direction Y is less than or equal to 0. Since the gap between the sub-spacer 36 corresponding to the i-th row of pixel regions 101 and the sub-spacer 36 corresponding to the (i+1)-th row of pixel regions 101 in the second direction Y is less than or equal to 0, a dimension, in the second direction Y, of the total area that the spacer 30 abuts against the sub-spacers 36 may be greater than or equal to a dimension, in the second direction Y, of the first surface 301, which increases the total area that the spacer 30 abuts against the sub-spacers 36 and improves the supporting strength of the spacer, which is conducive to improving the uniformity of the thickness of the cell.

For examples, as shown in FIG. 27, when a bottom border of the sub-spacer 36a is flush with a top border of the sub-spacer 36b, the gap between the sub-spacer 36a and the sub-spacer 36b in the second direction Y is equal to 0. As shown in FIG. 31, when the sub-spacer 36a and the sub-spacer 36b overlap in the second direction Y, or when projections of the sub-spacer 36a and the sub-spacer 36b in the first direction X partially overlap, the gap between the sub-spacer 36a and the sub-spacer 36b in the second direction Y is less than 0. As shown in FIG. 30, when the plurality of pixel regions 101 are arranged in a plurality of rows and a plurality of columns, the sub-spacer 36a and the sub-spacer 36b in adjacent rows are connected together, that is, the gap between the sub-spacer 36a and the sub-spacer 36b in the second direction Y is equal to zero.

In some embodiments, as shown in FIG. 27, a dimension L1 of the first surface 301 in the first direction X is greater than or equal to a distance K1 between two adjacent pixel regions 101 in the first direction X. In this way, when an alignment deviation of the spacer 30 in the first direction X relative to the sub-spacer 36 occurs, for example, when the spacer 30 moves to the right relative to the sub-spacer 36 so that the spacer 30 abuts against a sub-spacer 36c, an area that the spacer 30 abuts against the sub-spacer 36c increases from 0 to ΔS5, and the area that the spacer 30 abuts against the sub-spacer 36a remains unchanged or decreases by ΔS6, where ΔS6≤ΔS5. Therefore, when the spacer 30 moves to the right relative to the sub-spacer 36, the total area that the spacer 30 abuts against the sub-spacers 36 remains unchanged or increases. When the spacer 30 moves to the left relative to the sub-spacer 36, the total area that the spacer 30 abuts against the sub-spacers 36 remains unchanged or increases.

In the embodiments of the present disclosure, the dimension L1 of the first surface 301 in the first direction X is greater than or equal to the distance K1 between two adjacent pixel regions 101 in the first direction X; therefore, when the spacer 30 and the sub-spacer 36 have an alignment deviation in the first direction X, it may ensure that the total area that the spacer 30 abuts against the sub-spacers 36 remains unchanged or increases, ensure the supporting strength of the spacer 30 and the sub-spacer 36, and is conducive to maintaining the uniformity of the thickness of the cell. In addition, when the spacer 30 slides in the second direction Y, the spacer 30 will not completely slide to be between two adjacent sub-spacers 36, so that the spacer 30 is at least lapped on one sub-spacer 36, which prevents the spacer 30 from scratching the alignment film in the pixel region 101 in the array substrate 100, and reduces the risk of light leakage of the display substrate.

In addition, the thickness of the spacer 30 may also affect coating the color filter substrate with the alignment film (the second alignment film), which causes disorder in the liquid crystal layer at a position near the spacer 30. In the present disclosure, when the thickness of the liquid crystal layer (a gap between the array substrate and the color filter substrate) remains unchanged, by providing the sub-spacers 36 on the array substrate 100, it is also conducive to reducing a dimension of the spacer 30 in a direction perpendicular to the second base 20, that is, reducing the thickness of the spacer 30, reducing the disorder of the liquid crystal layer at the position of the spacer 30 caused by the alignment film, reducing an area of a region of light leakage caused by the spacer 30, and improving an aperture ratio of the display substrate.

In some embodiments, as shown in FIGS. 27 to 31, in the case where the array substrate 100 includes the sub-spacers 36, the array substrate 100 further includes a light-shielding layer 120, the light-shielding layer 120 is disposed on a side of the first base substrate 110 close to the color filter substrate 200, and the sub-spacers 36 are located on a side of the light-shielding layer 120 close to the color filter substrate 200. In other words, the light-shielding layer 120 is disposed between the first base substrate 110 and the sub-spacers 36. An orthographic projection of the light-shielding layer 120 on the first base substrate 110 does not overlap with the orthographic projections of the pixel regions 101 on the first base substrate 110. In other words, the light-shielding layer 120 is located outside the pixel regions 101. The orthographic projections of the sub-spacers 36 on the first base substrate 110 are located within the orthographic projection of the light-shielding layer 120 on the first base substrate 110. The light-shielding layer 120 may reduce cross-color between adjacent pixel regions and improve display performance. For example, the orthographic projection of the black matrix 21 on the array substrate 100 overlaps with a part of the light-shielding layer 120; for example, the orthographic projection of the black matrix 21 on the array substrate 100 covers the light-shielding layer 120.

In some embodiments, as shown in FIG. 27, each edge of the sub-spacer 36 is indented inward the same distance relative to a corresponding edge of the light-shielding layer 120. In other words, a distance between an edge of the orthographic projection of the sub-spacer 36 on the first base substrate 110 and a corresponding edge of an orthographic projection of the light-shielding layer 120 on the first base substrate 110 is the same.

As shown in FIG. 27, the light-shielding layer 120 may include first light-shielding strips 121 and second light-shielding strips 122. The first light-shielding strips 121 extend in the first direction X, and a first light-shielding strip 121 is located between two adjacent rows of pixel regions 101. The second light-shielding strips 122 extend in the second direction Y, and a second light-shielding strips 122 is located between two adjacent pixel regions 101 in the first direction X. At least a portion of the sub-spacer 36 is located on the second light-shielding strip 122.

For example, each edge of the sub-spacer 36 is indented inward the same distance relative to a corresponding edge of the light-shielding layer 120, which can be understood that, as shown in FIG. 27, a distance between a left edge of the sub-spacer 36 and a corresponding left edge of the second light-shielding strip 122 is a first distance; a distance between a right edge of the sub-spacer 36 and a corresponding right edge of the second light-shielding strip 122 is the first distance; a distance between a top edge of the sub-spacer 36 and a corresponding top edge of the first light-shielding strip 121 is the first distance; and a distance between a bottom edge of the sub-spacer 36 and a corresponding bottom edge of the first light-shielding strip 121 is the first distance.

A difference between a dimension W1 of the second light-shielding strip 122 in the first direction X and a dimension W2 of the sub-spacer 36 in the first direction X is the same as a dimension W3 of the first light-shielding strip 121 in the second direction Y. For example, W1 may be approximately 2.6 μm, and W2 may be approximately 1 μm. The values of W1 and W2 can be set according to needs, which are not specifically limited here.

For example, the orthographic projection of the sub-spacer 36 on the first base substrate 110 may be located on inner sides of two borders, parallel to the second direction Y, of the second light-shielding strip 122. An orthographic projection of the first surface 301 on the first base substrate 110 is located within an orthographic projection of the first light-shielding strip 121 on the first base substrate 110. Therefore, the sub-spacers 36 and the spacers 30 do not affect the light transmittance of the display substrate.

In some embodiments, a center of the sub-spacer 36 is aligned with a center of the second light-shielding strip 122. A dimension L2 of the sub-spacer 36 in the second direction Y is greater than a dimension L3 of the pixel region 101 in the second direction Y, and a distance K3 between an edge of the sub-spacer 36 parallel to the first direction X and a corresponding edge of the first light-shielding strip 121 is half of the dimension W3 of the first light-shielding strip 121 in the second direction Y. A distance between an edge of the sub-spacer 36 and a corresponding edge of the second light-shielding strip 122 is half of the dimension W3 of the first light-shielding strip 121 in the second direction Y. That is to say, a distance by which each edge of the sub-spacer 36 is indented inward relative to the corresponding edge of the light-shielding layer 120 is half of the dimension W3 of the first light-shielding strip 121 in the second direction Y.

For example, the light-shielding layer 120 may be made of a blackened metal material, and the blackened metal material may be a metal material having a light-shielding rate greater than a first threshold value. The first threshold value may be, for example, 80%, 85%, 90% or 95%, etc., which will not be listed one by one in the embodiments of the present disclosure. The blackened metal material includes but is not limited to at least one of molybdenum (Mo), aluminum (Al), molybdenum niobium (MoNb), or molybdenum-nickel-titanium (MTD). The sub-spacer 36 may be made of an inorganic material and/or an organic material. The inorganic material may include one or more of metal oxide and a blackened metal material, and the metal oxide may include but is not limited to silicon nitride, silicon oxide, titanium nitride, molybdenum nitride, molybdenum oxide, niobium oxide, niobium nitride, etc. The light-shielding layer 120 and the sub-spacer 36 may be formed by one mask process, for example, by wet etching and dry etching, so that the light-shielding layer 120 and the sub-spacer 36 form a step shape due to the difference in etching bias between the sub-spacer 36 and the light-shielding layer 120.

In the array substrate 100 in the embodiments of the present disclosure, each edge of the sub-spacer 36 is indented inward the same distance relative to a corresponding edge of the light-shielding layer 120. Therefore, when the sub-spacers 36 are formed on the light-shielding layer 120, the sub-spacers 36 may be formed using a self-alignment process, which ensures that a distance between a border of the light-shielding layer 120 and a corresponding border of the sub-spacer 36 is the same, reduces the impact of process fluctuations on the size of the sub-spacer 36, and in turn reduces the impact of process fluctuations on the aperture ratio.

For example, the light-shielding layer 120 may be connected to the first electrodes (the common electrodes) of the array substrate, so that the light-shielding layer 120 may be used as a common electrode layer of the array substrate 100.

In some embodiments, as shown in FIGS. 28 and 29, the color filter substrate 200 may further includes a black matrix 21. The black matrix 21 is located on a side of the second base 20 facing the array substrate 100, and the spacers 30 are located on a side of the black matrix 21 facing away from the second base 20. An orthographic projection of the spacer 30 on the second base 20 is located within an orthographic projection of the black matrix 21 on the second base 20.

In an example, the dimension L1 of the first surface 301 of the spacer 30 in the first direction X is 6 μm, and a dimension W51 of the first surface 301 in the second direction Y is approximately 1 μm. A dimension, in the first direction X, of a surface of the spacer 30 close to the second base 20 is approximately 7 μm, and a dimension, in the second direction Y, of the surface of the spacer 30 close to the second base 20 is approximately 2 μm. A dimension L5 of the black matrix 21 in the first direction X is 10.1 μm, and a dimension W5 of the black matrix 21 in the second direction Y is 5.1 μm. A height of the first spacer is approximately 0.6 μm, and a height of the spacer 30 is approximately 1.3 μm.

In some embodiments, as shown in FIGS. 27 and 28, a portion of the first surface 301 of the spacer 30 away from the second base 20 that abuts against the sub-spacer 36 forms a main spacer region 302. In addition, a portion of the orthographic projection of the first surface 301 on the array substrate 100 that overlaps with the light-shielding layer 120 and is not in contact with the sub-spacer 36 may form a first secondary spacer region 303.

In some embodiments, referring to FIGS. 27 and 28, the distance between the surface of the spacer 30 away from the second base 20 and the second base 20 is equal. The first surface 301 of the spacer 30 away from the second base 20 abuts against the sub-spacer 36. The spacer 30 can cooperate with the sub-spacer 36 to form different spacer regions of the spacer 30.

In a case where the display substrate 1100 is in a normal state (under no pressure), the main spacer region 302 of the spacer 30 provides support for a thickness of the liquid crystal cell. When the display substrate 1100 is under pressure, the color filter substrate 200 is pressed toward a side close to the array substrate 100, the spacer 30 is pressed and deformed, and the first secondary spacer region 303 of the spacer 30 starts to participate in supporting the thickness of the liquid crystal cell, that is, the spacer 30 is in contact with the light-shielding layer 120 on the array substrate 100.

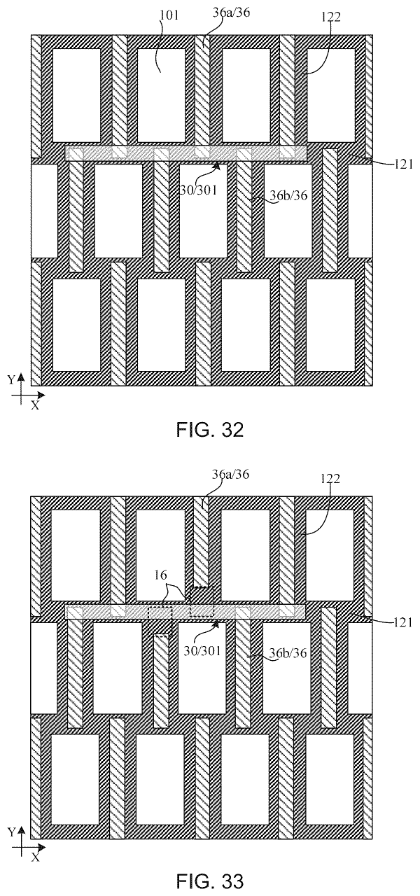

The dimension of the spacer 30 in the first direction X can be set according to needs. In some other embodiments, referring to FIG. 32, the dimension of the spacer 30 in the first direction X may be greater than the distance between two pixel regions 101; for example, the orthographic projection of the spacer 30 on the array substrate 100 overlaps with at least three sub-spacers 36 in the same row. For example, the orthographic projection of the spacer 30 on the array substrate 100 overlaps with 3, 4, 6, 8, 10, or any number of sub-spacers 36 in the same row.

The arrangement density of the spacers 30 is negatively correlated with the length of the spacer 30 in the first direction X. For example, as the length of the spacer 30 in the first direction X increases, the number of the spacers 30 decreases. By adjusting the arrangement density and arrangement manner of the spacers 30, the density of the orthographic projection of the main spacer region 302 on the array substrate 100 may be made to be 50 μm²/mm² to 300 μm²/mm², and the density of the orthographic projection of the first secondary spacer region 303 on the array substrate 100 may be made to be 5000 μm²/mm² to 20000 μm²/mm², so as to ensure that the main spacer region 302 may provide good support for the thickness of the liquid crystal cell and is not easily prone to mura under external force.

Of course, in order to adjust the ratio between the main spacer region 302 and the first secondary spacer region 303 formed by the spacer 30, referring to FIG. 33, the array substrate 100 may further include a plurality of avoidance regions 16. In the avoidance region 16, the orthographic projection of the spacer 30 on the array substrate 100 overlaps with the first light-shielding strip 121, and the spacer 30 is not contact with the sub-spacer 36.

For example, the avoidance region 16 is located within the light-shielding layer 120 and does not overlap with the sub-spacer 36. For example, an avoidance region 16 may be located on the first light-shielding strip 121 and at a position that is opposite to at least one sub-spacer 36. An end of at least one sub-spacer 36 in the second direction Y does not extend onto the first light-shielding strip 121, so as to form an avoidance region 16. By increasing the quantity of avoidance regions 16, the area proportion of the first secondary spacer region 303 formed by the spacer 30 may be increased, and the area proportion of the main spacer region 302 may be reduced, so that the area ratio between the main spacer regions 302 and the first secondary spacer regions 303 is close to 1:100. Based on this ratio, the main spacer region 302 and the first secondary spacer region 303 may satisfy the requirement of supporting the thickness of the liquid crystal cell and the requirement of no mura under external pressure.

In the embodiments of the present disclosure, the length of the spacer 30 in the second direction Y, the arrangement manner and arrangement density of the spacers 30, and the quantity and distribution density of the avoidance regions 16 provided in the array substrate are not listed one by one.

The embodiments of the present disclosure further provide a method for manufacturing a display substrate. The display substrate includes a plurality of rows of pixel regions 101. The method includes steps S11 to S13.

In step S11, an array substrate 100 is formed. This step may include forming sub-spacers 36 on a side of a first base substrate 110, where a sub-spacer 36 is located between two adjacent pixel regions 101 in a first direction X, and the sub-spacers 36 extend in a second direction Y, the first direction X being a direction in which a row of pixel regions 101 are arranged.

In step S12, a color filter substrate 200 is provided. The color filter substrate 200 includes a second base 20 and spacers 30 disposed on a side of the second base 20, the spacers 30 extending in the first direction X.

In step S13, the color filter substrate 200 and the array substrate 100 are assembled. The spacer 30 abuts against a sub-spacer 36 corresponding to an i-th row of pixel regions 101, and the spacer 30 abuts against a sub-spacer 36 corresponding to an (i+1)-th row of pixel regions 101, where i is a natural number greater than or equal to 1.

In some embodiments, the array substrate 100 further includes a light-shielding layer 120, the light-shielding layer 120 is disposed on a side of the first base substrate 110 facing the sub-spacers 36, and the sub-spacers 36 are located on a side of the light-shielding layer 120 facing the color filter substrate 200.

Referring to FIGS. 35A to 35C, forming the sub-spacers 36 and the light-shielding layer 120 on the side of the first base substrate 110, includes: sequentially depositing a light-shielding material layer and a spacer material layer on the side of the first base substrate 110; forming a photoresist pattern 40 on a side of the spacer material layer away from the first base substrate 110, where an orthographic projection of the photoresist pattern 40 on the first base substrate 110 overlap with a region where the light-shielding layer 120 is to be formed on the first base substrate 110; etching the spacer material layer 36′ using a wet etching process, so that a remaining spacer material forms the sub-spacers 36, and an edge of a sub-spacer 36 is indented inward a preset distance M relative to a corresponding edge of the photoresist pattern 40; and etching the light-shielding material layer using a dry etching process to remove a light-shielding material outside a region where the photoresist pattern 40 is located, so that a light-shielding material located in the region where the photoresist pattern 40 is located forms the light-shielding layer 120.

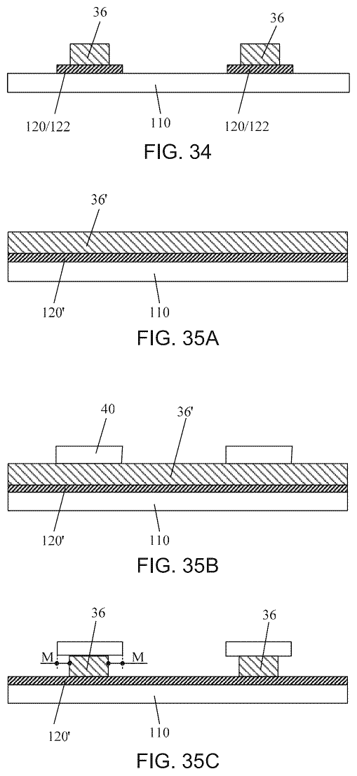

FIG. 34 is a schematic sectional view taken along the B3-B3 line in FIG. 27. The process of forming the array substrate 100 is further introduced below by taking FIG. 34 as an example. It can be understood that for “patterning” mentioned herein, when a patterned material is an inorganic material or metal, “patterning” includes processes such as coating photoresist, mask exposure, development, etching, and lift-off photoresist; when a patterned material is an organic material, “patterning” includes processes such as mask exposure and development. The evaporation, deposition, coating, and coating mentioned herein are all mature manufacturing processes in the related art.

The light-shielding material layer 120′ and the spacer material layer 36′ are sequentially deposited on the side of the first base substrate 110, as shown in FIG. 35A. FIG. 35A is a schematic sectional view of an array substrate where a spacer material layer has been deposited. For example, a material of the light-shielding material layer may include a first metal, a material of the spacer material layer may include a second metal, and the material of the light-shielding material layer is different from the material of the spacer material layer.

A side of the spacer material layer away from the first base substrate 110 is coated with a photoresist; the photoresist is exposed and developed to form the photoresist pattern 40, and the orthographic projection of the photoresist pattern 40 on the first base substrate 110 overlap with the region where the light-shielding layer 120 is to be formed on the first base substrate 110, as shown in FIG. 35B. FIG. 35B is a schematic sectional view of an array substrate where a photoresist pattern has been formed.

The spacer material layer 36′ is etched using a wet etching process, and the remaining spacer material forms the sub-spacers 36, and the edge of the sub-spacer 36 is indented inward the preset distance M relative to the corresponding edge of the photoresist pattern 40, as shown in FIG. 35C. FIG. 35C is a schematic sectional view of an array substrate where first spacers have been formed.

The light-shielding material layer 120′ is etched using a dry etching process to remove a light-shielding material outside a region where the photoresist pattern 40 is located, so that a light-shielding material located in the region where the photoresist pattern 40 is located forms the light-shielding layer 120. The light-shielding layer 120 is located in a region outside the pixel regions 101. The array substrate as shown in FIGS. 34 and 27 is obtained after the photoresist pattern is peeled off. Borders of the orthographic projection of the light-shielding layer 120 on the first base substrate 110 and the orthographic projection of the photoresist pattern 40 on the first base substrate 110 overlap. Since the sub-spacers 36 are formed by using the photoresist pattern 40 and the wet etching process, each edge of the sub-spacer 36 is indented inward the same distance relative to a corresponding edge of the light-shielding layer 120.

It will be noted that, when the spacer material layer is etched using the wet etching process, the wet etching process will not etch the light-shielding material layer. For example, the material of the light-shielding layer 120 may include the first metal, and the material of the sub-spacers 36 may include the second metal. For example, the first metal may be titanium (Ti), and the second metal may be molybdenum (Mo). A suitable wet etching process may be selected according to the material of the sub-spacers 36 and the material of the light-shielding layer 120, so that the wet etching process can etch the material of the spacers without etching the material of the light-shielding layer. The material of the light-shielding layer 120 and the material of the sub-spacers 36 may be selected in conjunction with the wet etching process, so that the wet etching process can etch the material of the spacers without etching the material of the light-shielding layer.

In the array substrate formed by the method in the embodiments of the present disclosure, as shown in FIG. 27, each edge of the sub-spacer 36 is indented inward the same distance relative to a corresponding edge of the light-shielding layer 120. The difference between the dimension W1 of the second light-shielding strip 122 in the first direction X and the dimension W2 of the sub-spacer 36 in the first direction X is the same as the dimension W3 of the first light-shielding strip 121 in the second direction Y. The center of the sub-spacer 36 is aligned with the center of the second light-shielding strip 122. The dimension L2 of the sub-spacer 36 in the second direction Y is greater than the dimension L3 of the pixel region 101 in the second direction Y, and the distance K3 between the edge of the sub-spacer 36 parallel to the first direction X and the corresponding edge of the first light-shielding strip 121 is half of the dimension W3 of the first light-shielding strip 121 in the second direction Y. The distance between the edge of the sub-spacer 36 and the corresponding edge of the second light-shielding strip 122 is half of the dimension W3 of the first light-shielding strip 121 in the second direction Y. In this way, during the wet etching process, a self-alignment process may be used to achieve that each border of the sub-spacer 36 is indented inward the same distance relative to a corresponding border of the light-shielding layer 120; therefore, W1−W2=W3, K3=W3*(½), and the preset distance M=W3*(½), which ensure that the center of the sub-spacer 36 is aligned with the center of the second light-shielding strip 122, which is conducive to improving the accuracy of the sizes of the light-shielding layer 120 and the sub-spacers 36.

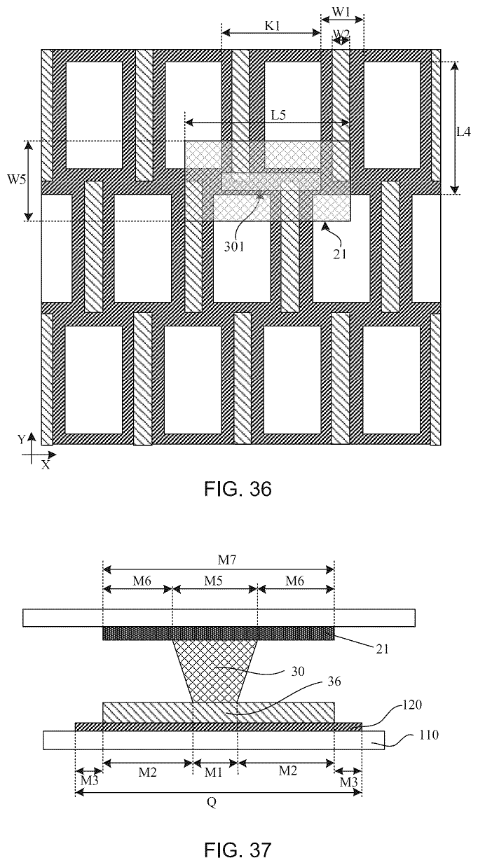

FIG. 36 is a schematic plan view of an array substrate in a display substrate in an embodiment of the present disclosure. FIG. 36 also schematically shows a first surface 301 and a black matrix 21. Considering an example in which a size of a sub-pixel of the display substrate in reality is 6 μm*8 μm (i.e., in FIG. 34, K1=6 μm and L4=8 μm), the dimension W1 of the second light-shielding strip 122 in the first direction X is approximately 2.6 μm, the dimension W3 of the first light-shielding strip 121 in the second direction Y is approximately 1.6 μm, L2 of the sub-spacer 36 formed using the self-alignment process is approximately 8 μm, and W2 is approximately 1 μm. Correspondingly, the dimension of the first surface 301 of the spacer 30 in the second direction Y is approximately 1 μm, and the dimension of the first surface 301 in the first direction X is approximately 6 μm. The dimension W5 of the required black matrix 21 is approximately 5.1 μm, and L5 is approximately 10.1 μm. Assuming that the density of the total area that the sub-spacers 36 abut against the spacers 30 is approximately 320 μm²/mm², it is calculated that the aperture ratio of the display substrate is approximately 37.8%.

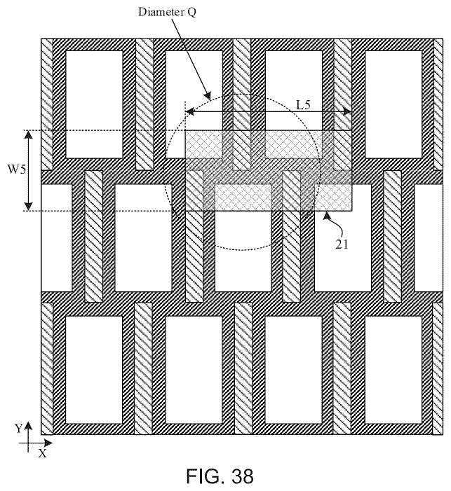

FIG. 37 is a cross-sectional schematic diagram of a display substrate in the related art. FIG. 38 is a schematic diagram showing a size comparison of an opaque pattern in an array substrate in the related art and an opaque pattern in an array substrate in the present disclosure. FIG. 38 shows the projection of the black matrix 21 in the present disclosure on the array substrate 100 and the projection of the pattern of the light-shielding layer 120 in the related art. In FIG. 38, the present disclosure and the related art have the same resolution.

As shown in FIG. 37, the array substrate 100 includes a first base substrate 110, a light-shielding layer 120 and a sub-spacer 36. The sub-spacer 36 is in a shape of a circle, and the spacer 30 is in a shape of a circle. In the related art, it is necessary to consider the influence of the alignment deviation on the area that the sub-spacer 36 abuts against the spacer 30. When the alignment deviation M2 is approximately 3 μm and a diameter M1 of the first surface 301 of the spacer 30 is approximately 1 μm, in order to ensure that the area that the sub-spacer 36 abuts against the spacer 30 remains unchanged within the alignment deviation, a diameter 2*M2+M1 of the sub-spacer 36 is approximately 7 μm, and correspondingly, a size of the light-shielding layer 120 is at least approximately 8.6 μm. Obviously, in the related art in FIG. 37, for a group of a sub-spacer 36 and a spacer 30 that abut against each other, a maximum diameter Q of an opaque pattern is approximately 8.6 μm; in the present disclosure, for a group of a sub-spacer 36 and a spacer 30 that abut against each other, a maximum size W5*L5 of an opaque pattern is approximately 5.1 μm*10.1 μm. Therefore, for the convenience of comparison, FIG. 38 shows a size of the light-shielding layer 120 in the related art and a size W5*L5 of the black matrix 21 in the present disclosure.

Assuming that the density of the total area that the sub-spacers 36 abut against the spacers 30 is approximately 320 μm²/mm², it is calculated that the aperture ratio of the display substrate is approximately 37.1%. Furthermore, when the alignment deviation is greater than 3 μm, the area that the sub-spacer 36 abuts against the spacer 30 decreases, resulting in insufficient support force and a risk of cell gap deviation.

From the above comparison, it can be seen that, under the same resolution and the same alignment deviation, compared with the related art, the technical solutions of the present disclosure improve the aperture ratio of the display substrate, and the alignment deviation will not decrease the area that the sub-spacer 36 abuts against the spacer 30. Therefore, the area that the sub-spacer 36 abuts against the spacer 30 is not affected by the alignment deviation, which ensures the supporting strength of the sub-spacers 36 and the spacers 30, which is conducive to maintaining the uniformity of the thickness of the cell.

In FIG. 37, M3 is approximately 0.8 μm, a diameter M5 of an upper surface of the spacer 30 is approximately 2 μm, a distance M6 between an edge of the upper surface of the spacer 30 and a corresponding edge of the black matrix 21 is approximately 1.55 μm, and M7 is approximately 5.1 μm. In FIG. 38, the diameter Q is approximately 8.6 μm.

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. For example, the above-mentioned multiple embodiments provided in the present disclosure may be implemented separately, or the above-mentioned multiple embodiments may be combined without conflict. Therefore, the protection scope of the present disclosure should be determined by the protection scope of the claims.

1. A display substrate, comprising an array substrate and a color filter substrate arranged opposite to each other, wherein
the array substrate includes:
a first base and a plurality of first signal lines disposed on a side of the first base, wherein the plurality of first signal lines are arranged at intervals in a first direction and all extend in a second direction, the first direction and the second direction intersecting; and
a plurality of signal line groups arranged at intervals in the second direction and all extending in the first direction, wherein the plurality of first signal lines and the plurality of signal line groups intersect with each other to constitute a mesh structure; a protruding structure, protruding toward a side away from the first base, is formed in an overlapping region of orthographic projections of a signal line group and a first signal line on the first base; the signal line group include avoidance regions; and an intersection of at least one signal line group and a first signal line is provided with an avoidance region; and
the color film substrate includes a second base and a plurality of spacers, wherein the plurality of spacers are disposed on a side of the second base close to the array substrate; the spacers are in a strip shape and extend in the first direction; an orthographic projection of a spacer on the array substrate partially overlaps with the first signal line, and partially overlaps with the signal line group; and in the avoidance region, the orthographic projection of the spacer on the array substrate does not overlap with the protruding structure.

2. The display substrate according to claim 1, wherein
a surface of the spacer away from the second base abuts against a portion of the protruding structure.

3. The display substrate according to claim 1, wherein
a distance between a surface of the spacer away from the second base and the second base is equal; and/or
in the avoidance region, the signal line group protrudes in the first direction.

4. (canceled)

5. The display substrate according to claim 3, wherein
the signal line group includes a second signal line, an orthographic projection of the second signal line on the second base partially overlaps with the spacer, a dimension of a surface of the spacer close to the array substrate in the second direction is D1, a width of the second signal line in the second direction is D2, and D1 is greater than D2.

6. The display substrate according to claim 3, wherein
the signal line group includes a second signal line and a third signal line; the orthographic projection of the spacer on the array substrate also covers a region between the second signal line and the third signal line; the orthographic projection of the spacer on the array substrate partially overlaps with the second signal line; and the orthographic projection of the spacer on the array substrate partially overlaps with the third signal line.

7. The display substrate according to claim 6, wherein
a dimension of a surface of the spacer close to the array substrate in the second direction is D1, a dimension of the second signal line in the second direction is D2, a dimension of the third signal line in the second direction is D3, and a distance between the second signal line and the third signal line is D4;
D1, D2, D3 and D4 satisfy: D2>D3, and D1=D4+D3; or
D1, D2, D3 and D4 satisfy: D3>D2, and D1=D4+D2.

8. The display substrate according to claim 6, wherein
an intersection of at least one second signal line and the first signal line is provided with an avoidance region, and/or an intersection of at least one third signal line and the first signal line is provided with an avoidance region; and
wherein the array substrate further includes a first electrode, and a surface, in the first direction, of a protruding structure of the third signal line in the avoidance region is connected to the first electrode.

9. (canceled)

10. The display substrate according to claim 1, wherein
a dimension of the spacer in the first direction is greater than a distance between two adjacent first signal lines.

11. The display substrate according to claim 10, wherein
the plurality of spacers include at least one first spacer; an orthographic projection of a first spacer on the array substrate overlaps with at least thirteen first signal lines, and overlaps with one signal line group; and at least eleven intersections among intersections of the at least thirteen first signal lines and the one signal line group are provided with avoidance regions.

12. The display substrate according to claim 11, wherein
the mesh structure composed of the plurality of first signal lines and the plurality of signal line groups defines a plurality of pixel regions; and at least one first spacer is arranged for every twenty-four pixel regions.

13. The display substrate according to claim 10, wherein
the plurality of spacers include at least one second spacer, an orthographic projection of a second spacer on the array substrate overlaps with three first signal lines, and overlaps with one signal line group; and the second spacer abuts against protruding structures formed at intersections of the three first signal lines and the one signal line group.

14. The display substrate according to claim 10, wherein
the plurality of spacers include at least one third spacer; an orthographic projection of a third spacer on the array substrate overlaps with one first signal line, and overlaps with one signal line group; and the third spacer abuts against a protruding structure formed at an intersection of the one first signal line and the one signal line group.

15. The display substrate according to claim 10, wherein
the plurality of spacers include at least one fourth spacer; an orthographic projection of a fourth spacer on the array substrate overlaps with three first signal lines, and overlaps with one signal line group; an intersection of the three first signal lines and the one signal line group is provided with two avoidance regions; and the fourth spacer abuts against a protruding structure formed at an intersection of one first signal line among the three first signal lines and the one signal line group.

16. The display substrate according to claim 11, wherein
the plurality of spacers include at least one fifth spacer; an orthographic projection of a fifth spacer on the array substrate overlaps with three first signal lines, and overlaps with one signal line group; each intersection of the three first signal lines and the one signal line group is provided with an avoidance region; and the fifth spacer is not contact with protruding structures formed at intersections of the three first signal lines and the one signal line group.

17. The display substrate according to claim 16, wherein
the mesh structure composed of the plurality of first signal lines and the plurality of signal line groups defines a plurality of pixel regions; and the array substrate includes a plurality of fourth spacers and a plurality of fifth spacers; and four fourth spacers and four fifth spacers are arranged for every forty-eight pixel regions; and
wherein the plurality of fourth spacers and the plurality of fifth spacers are arranged in rows in the first direction, and a row includes multiple fourth spacers and multiple fifth spacers that are alternately arranged; and/or the plurality of fourth s acers and the plurality of fifth spacers are arranged in columns in the second direction, and a column includes fourth spacers and fifth spacers that are alternately arranged.

18. (canceled)

19. The display substrate according to claim 11, wherein the spacer includes:
a main spacer region, wherein the main spacer region abuts against the protruding structure, and a density of an orthographic projection of the main spacer region on the array substrate is in a range of 50 μm²/mm² to 300 μm²/mm²; and
a first secondary spacer region, wherein the first secondary spacer region is not in contact with the protruding structure, an orthographic projection of the first secondary spacer region on the array substrate overlaps with the first signal line or the signal line group; and a density of the orthographic projection of the first secondary spacer region on the array substrate is in a range of 5000 μm²/mm² to 20000 μm²/mm².

20. The display substrate according to claim 10, wherein the color filter substrate further includes:
a black matrix, wherein the black matrix is disposed between the second base and the spacers, and an orthographic projection of the black matrix on the array substrate covers orthographic projections of the spacers on the array substrate, the first signal lines, and the signal line groups; and
wherein the black matrix includes:
first portions, wherein an orthographic projection of a first portion on the array substrate covers a portion of the first signal line close to the signal line group; and
second portions, wherein a second portion is located on a side of the first portion away from the signal line group, and is connected to the first portion; wherein
a dimension of the first portion in the first direction is greater than a dimension of the second portion in the first direction.

21. (canceled)

22. The display substrate according to claim 1, wherein
a thickness of the first signal line is in a range of 0.5 μm to 0.7 μm; and/or
a thickness of the signal line group is in a range of 0.5 μm to 0.7 μm.

23. The display substrate according to claim 1, wherein
the orthographic projection of the spacer on the array substrate partially overlaps with the signal line group or the first signal line; the spacer includes a main spacer region with a first thickness and a third secondary spacer region with a second thickness, and the first thickness is greater than the second thickness; an orthographic projection of the main spacer region on the array substrate overlaps with the first signal line; and the orthographic projection of the main spacer region on the array substrate does not overlap with the signal line group; and
wherein the orthographic projection of the main spacer region on the array substrate overlaps with at least two first signal lines.

24. (canceled)

25. A display device, comprising:
the display substrate according to claim 1; and
a driver circuit board electrically connected to the display substrate and configured to transmit control signals to the display substrate.
